(19) United States
(12) Patent Application Publication
(10) Pub. No.: US 2003/0236755 A1
(43) Pub. Date: Dec. 25, 2003

(54) Enhanced point-of-sale system

(76) Inventor: Richard Dagelet JR., Las Pinas City (PH)

Correspondence Address: Maria Erlinda C. Sarno, Esq., P.O. Box 1023, Artesia, CA, 90702, US

(21) Appl. No.: 10/161,292

(22) Filed: Jun. 3, 2002

(51) Int. Cl. G06F 17/60

(52) U.S. Cl. 705/68; 705/72

(57) ABSTRACT

A cardless system for dispensing prepaid products, replenishing balances or settling an account which avoids the expenses of producing tangible prepaid cards every time the balance on the prepaid card is consumed. The system also provides the ability to replenish balances on existing prepaid cards thereby avoiding the expense of producing additional cards, and reduce equipment and labor costs. This system helps the environment by saving these resources involved in the production of the present disposable tangible prepaid cards. Additionally, the system offers monitoring of store inventory and recording of sales transaction. The system can manage several prepaid products on a single customer prepaid product account and provide introduction of new products or deletion of old products without the need of reprogramming, reinitialization, collecting, upgrading and redistribution of the user terminals.

### BACKGROUND OF THE INVENTION

This invention generally relates to a system for electronic distributing, dispensing and recording transactions in accordance with prepaid services or goods and/or other terminal transactions or inventory data, such as discount rates and settlement flags, at one or more point-of-distribution locations, such as in a retail establishment.

Over the past few years, pre-paid cards such as cellular phone/internet cards, metro cards, gas cards, gift cards have become increasingly popular as a convenient way to pay for credits on phone calls or internet access, etc. Pre-paid cards look similar to credit cards, but they work like gift certificates for services. They may be purchased in selected denominations, thus allowing the holder of the card to receive the services or goods at any period of time within the allocated credit balance. For cellular phone/internet cards, for example, it allows the holder to make mobile calls or access the internet for the given allocated credit balance.

The front of a pre-paid card typically displays some type of logo and graphic image along with its corresponding amount of denomination. On the back side of the card, usually, a Card Number and Personal Identification Number (PIN) or Username and Password are indicated but initially hidden under an opaque surface-coating. After scratching away the coating, the revealed codes may be entered or utilized via a series of instructions. The instructions and other guidelines are significantly located at the back of the card. By following the steps, the holder can receive the card's denomination value on his/her current credit balance, as well as check and receive the audible account of his/her current credit balance at any given time.

In view of the increasing demand for prepaid cards, however, the reality behind their short-time usage and quick dispensability reflects great ideological losses. The card itself serves as nothing more than a portable physical host to simply carry concealed access codes until their values are loaded or utilized, after which the prepaid card is rendered useless and immediately disposed of. There is much waste on the effort, resources and cost allocated for the production of the physical prepaid cards, their design, numbering, physical delivery and distribution, and on other related components, such as allotted vending machines. Furthermore, the tangible means for the distribution and dispersal of such cards sometimes encounter stock unavailability, theft, illegal accessibility or fraud.

Distributors and dealers of tangible prepaid products oftentimes face difficulty in monitoring their stock and sales transactions. They are burdened with manual tracking of their inventory quantities and record of sales transactions, which sometimes imposes the problem of stock-outs. Thus, it is difficult to estimate stock replenishment and ordering on the part of dealers. Customers then suffer the negative effects of stock unavailability.

With the growing market demand, there is a need to introduce new additional prepaid value cards for the convenience of the customers. Unfortunately, the process entails time and expense before it can be released to the market; not mentioning the waste experienced when a particular prepaid value card becomes obsolete and has to be thrown.

It is therefore an object of the present invention to provide a Point-of-Sale system for distributing prepaid services to customers without the need or use of tangible prepaid cards.

It is a further object of this invention to provide an improved system for the management and distribution of prepaid card values to customers without discarding existing physical pre-paid cards, thereby avoiding the ideological wastages associated with the present practice.

It is also an object of this invention to provide a system of increasing the available balance of an existing tangible prepaid card without buying or printing a new prepaid card.

It is also a further object of this invention to provide prepaid services on a variety of services and goods on a single account with capabilities of settling each account when desired.

It is also another object of this invention to provide prepaid services on new services or goods to customers without the need of new reprogramming, reinitialization of existing point-of-sale terminals thereby preventing the cost and expenses associated with collecting, upgrading and redistributing point-of-sale terminals.

### SUMMARY OF THE INVENTION

A cardless point-of-sale (POS) system for dispensing prepaid products, replenishing balances or settling an account comprises a server, the server comprising a host server, a database server, the database server storing and distributing data and information on the system, a web server and an application server linked by a network/switch hub for routing data through a common transmission control protocol/internet protocol network (TCP/IP) for network connection to a concentrator; a POS terminal communicating with the host server through the concentrator, the POS terminal containing memory for programs designed for dispensing prepaid product information; a network operating system on a separate firewall server, the firewall server shielding the system and the web server; a router connected to the firewall, the router acting as a gateway for internet services within the network; an E-POS backend system within the application server for maintaining a database used in transactions operated by the E-POS system or the database server. Each POS terminal is initialized and activated prior to use. The system can process multiple transactions simultaneously without affecting the operational performance or efficiency of the system. To ensure continuance of system operations, the database is replicated and backed up by the system.

A process for dispensing prepaid products or prepaid credit replenishment using an E-POS system, comprising: initializing a terminal for dispensing prepaid product information; activating a POS terminal by a user; inputting an encrypted customer request to the POS terminal; transmitting the encrypted customer request to a host server from a POS terminal through a concentrator by the user; retrieving and loading the encrypted customer request to an application server, the application server temporarily decrypting and converting the request into a correct database format for storage into a database; receiving and validating a user request received from the POS terminal by the host server through information stored into a database; conveying the validated user request to the requesting POS terminal; checking if both host server and POS terminal are active; processing the validated user request by the POS terminal; and, dispensing the user request to the consumer/customer.

The basic processes done by the EPOS system here are sales, settlement and parameter downloading. The sales procedures are in turn exemplified by a batch download, instantaneous batch download and top-up transaction based on the type of POS terminal used or the type of customer requesting the prepaid product. For POS terminals that have memories capable of storing customer request inventories, a batch download is usually used but for POS terminals with limited memories, an instantaneous batch downloading is used. Top-transactions are usually opted by customers who want the prepaid product or credit immediately registered to her account instead of receiving the sale voucher.

Settlement allows a user to settle customer's prepaid account which is accessible to users to determine if there are any problems in the system Parameter downloading is a feature offered by the system wherein new products may be introduced or deleted and terminal tags, which are parameters used by the POS terminal to ensure security issues such as time of allowed sales of every terminal, maximum number of allowed sales by a POS terminal, etc. changed without the need of reprogramming, reinitialization, collection and redistribution of the POS terminals.

The system offers the users the option to print all sales transactions or any time of the day before settlement.

### BRIEF DESCRIPTION OF THE DRAWINGS

FIG. 1 is the basic network configuration of the E-POS system.

FIG. 1A illustrates the alternative way of connecting a concentrator to the Host Server via serial communication.

FIG. 2 illustrates the general flow of the system data and parameters in conjunction with the network configuration and system operations.

FIG. 3 shows the top view of a POS Terminal and its basic parts using Schlumberger MagIC 8000 model in particular.

FIGS. 3A-3P shows the step-by-step occurrence of each of the POS terminal function.

FIG. 4 illustrates the process setting up of parameters unto a POS terminal prior to distribution to instigate its POS terminal functions.

FIG. 5 is a tabular list of the functions performed by a POS terminal system made possible through the E-POS software program embedded/installed in the terminal's memory during its initial setup.

FIG. 6 depicts a close-up view of a sample E-POS carbonized paper voucher and its basic parts.

FIG. 7 shows the detailed parts of a POS Terminal Handset (also using Schlumberger MagIC 8000 model).

FIG. 8 gives the navigational chart of the E-POS Back-End System modules which may only be accessed by the assigned administration officers of the system.

FIG. 9 is a tabular list of the E-POS web reports accessible accordingly to the affiliated distributors and dealers of the system.

FIG. 10 is a table of the valid types of E-POS access cards, their designated functions and the recommended holders to use them.

FIG. 11 is a table listing of the security and control measures implemented by the E-POS, their detailed description and corresponding examples.

FIG. 12 displays the process flow and time periods involved in the Cycle for Prepaid Credit Replenishment with Independent Downloading.

FIG. 13 displays the step-by-step tasks of the Batch Download process done usually at the start of a working day.

FIGS. 14A-C shows a flowchart representing sales transaction by batch downloading method

FIGS. 15A-B shows a flowchart representing sales transaction by Instantaneous Batch Downloading method

FIGS. 16A-C shows a flowchart representing sales transaction by Top Up method

FIG. 17 displays the step-by-step process flow of a Pont-Of-Sale Transaction done with instantaneous downloading at the start and the course of a working day.

FIG. 18 displays the step-by-step process flow of a Top Up Transaction done at the start and the course of a working day.

FIGS. 19A-F shows a flowchart describing the steps occurring on the Host side of E-POS prior to download of data to the POS terminal.

FIGS. 20A-20F depicts the operations occurring on the POS terminal.

### DEFINITIONS

Accredited Distributors—term used to describe the persons given the authority to render services or goods offered by the E-POS system to end customers.

Biberon Card—this is a tool used by system developers during the development of programs to be loaded on the POS terminal.

Concentrator—term used to refer to Electronic Fund Transfer Point-of-Sale Concentrator

FTP—File Transfer Protocol; refers to an Internet procedure that makes possible the exchange of files on the Internet

MAC—abridged term for Message Authentication Code

Packet formats—refer to the customized formatting standard used by the developers to indicate program references.

PINs—abridged term for Personal Identification Numbers

### DETAILED DESCRIPTION OF PREFERRED EMBODIMENTS

The present invention may be understood more readily by reference to the following detailed description of the invention and the Figures.

Before the present devices and methods are disclosed and described, it is to be understood that the terminology used herein is for the purpose of describing more clearly the aspects of the invention and is not intended to be limiting. It must be noted that, as used in the specification and the appended claims, the singular forms “a,” “an” and “the” include plural references unless the context clearly dictates otherwise.

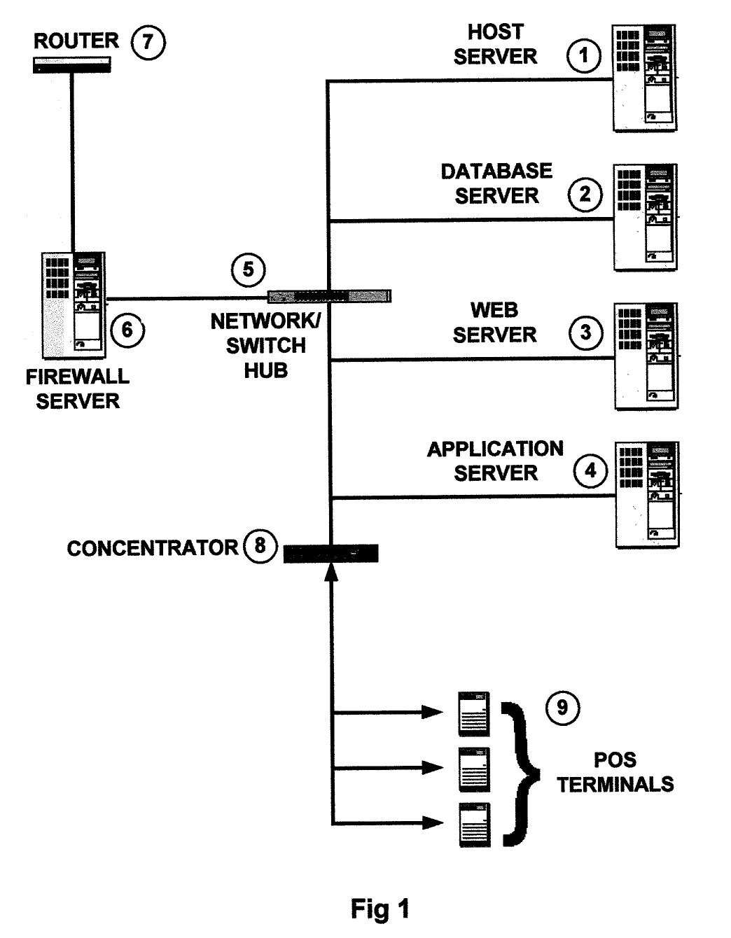

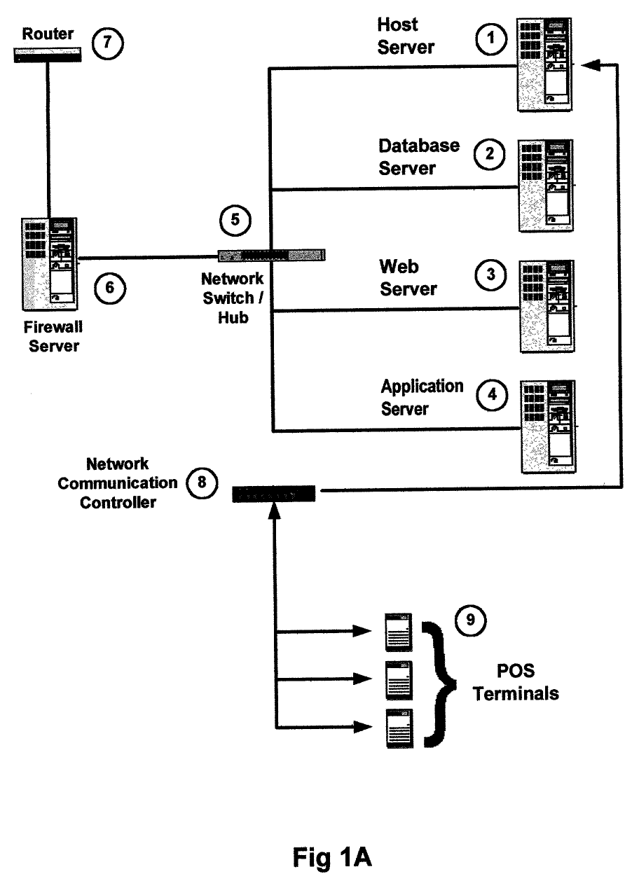

The basic network of the present E-POS system configuration as shown in FIG. 1 is comprised of four major servers: the Host Server 1, Database Server 2, Web Server 3 and Application server 4. They are linked to a common TCP/IP Network Switch/Hub 5 which interfaces with the POS terminals through a concentrator. TCP/IP stands for Transmission Control Protocol/Internet Protocol which is the suite of communications protocol used to connect host servers on the Internet. Alternatively, the concentrator is linked directly to the Host Server 1 which in turn is linked to the network/switch hub as shown in FIG. 1A.

The network operating system is preferably run on Windows NT or higher version with ISA Firewall on a separate Firewall Server 6. However, the system is not restrictive with regard to the use of operating system. It can run on other operating systems. This Firewall Server 6 prevents unauthorized access into the system, shields the Web Server 3 from attacks, and also filters internet traffic. This hardware posts the security of all data that are transmitted within the entire system. The firewall is connected to a Router 7 that acts as a Gateway for internet services within the network.

The Host, the Host Server 1 programmed to primarily control the communication between the Host Server 1 and the POS terminal hereinafter, also simply referred to as Host Server 1, interfaces with a concentrator via TCP/IP or serial communication. The concentrator used for illustration is a Network Communications Controller or NCC 8 interfacing via TCP/IP is shown in FIG. 1 while the connection via serial communication is shown in FIG. 1A. The Host system enables simultaneous processing of multiple transactions without affecting the operational performance or efficiency of the system. When the POS terminals 9 send transmissions, the Host accepts their requests and responds accordingly. The Host also functions to authenticate terminal identification such as detecting whether the terminal and user are active, validate packet formats and process sales transactions incurred by the POS terminals 9. The concentrator, herein the Network Communication Controller 8 as example, serves to route the transaction information i.e. data from the Host to the POS terminals 9, hereinafter also referred to simply as terminal/s, and vice versa.

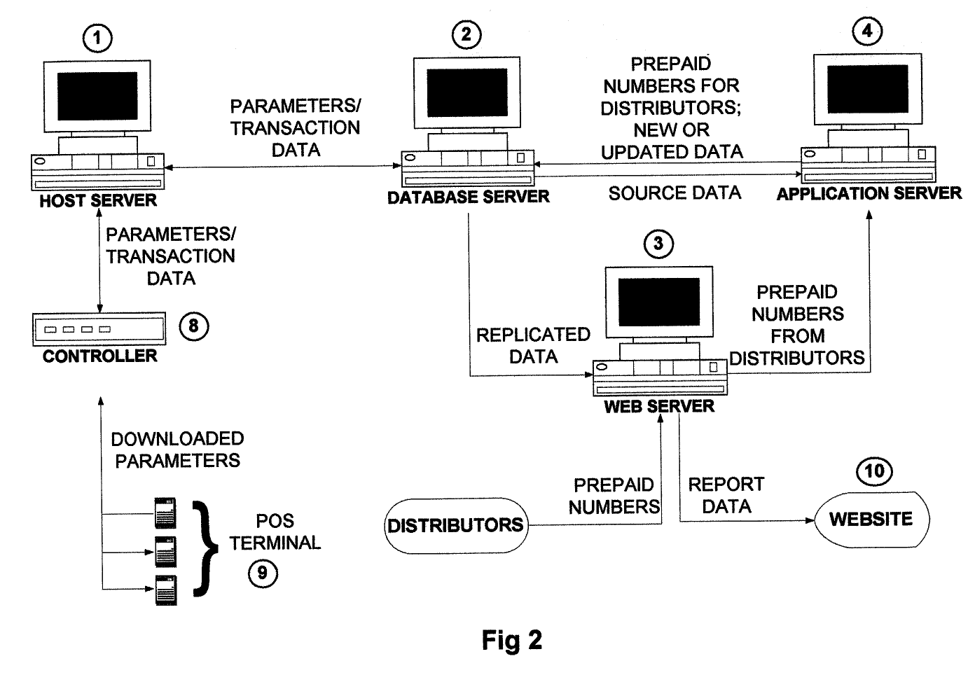

In relation to the aforementioned network configuration, the operational flow of the system data is illustrated in FIG. 2. The main database of the system resides securely in the Database Server 2. The database was designed to handle over one million transactions each month with enough processing capability to take on the volume of more than one telco or telecommunication company. It can store real-time transactions data and information on the system-accredited distributors, and acts as the source distributor for data replication. On a periodic frequency, usually minutes at a time, the database is replicated and backed up for reference and contingency measures. The replication process is handled by the Database Server 2 then migrated to the Web Server 3 as secondary backup. Thus, if the Host Server 1 fails, the Web Server 3 may be used for the continuance of the system operations.

The Web Server 3 also acts as the repository of computed data referenced for the system reports. It is through a website or intranet 10 residing within the Web Server 3 that accredited distributors and dealers can view and print reports pertaining to inventory and sales transactions. Daily, weekly and monthly information may be retrieved via Internet for convenient yet secured terminal user access.

Although the Database Server 2 houses all tables and indexes of the system data, the Database Server does not generate the key parameters such as prepaid PINs, Usernames, Passwords, etc or inventories for dispensing to the end customers. These are imported to the Database Server after generation. The generation process will be described later. It is the Application Server 4 that temporarily executes the process of decrypting and converting the key parameters in text formats such as PINs, Card Numbers, Usernames, etc into the correct database format for importation into the Database Server. In addition, the Application Server 4 serves to control transaction setup, load inventories to the Database Server 2, update terminal parameters i.e. headers and footers for new products notices, sales controls such as time of transaction, number of sales, maximum sales amount, number of terminal users and monitor the integrity of the system data by a process such as MAC.

A POS (Point-Of-Sale) terminal is a major component of the E-POS system. It is an electronic device which can perform display, storage, communication and printing functions depending on the configuration embedded in its memory. It is presently used for credit and debit transactions in relation to banks, for door lock security, sales transactions, inventory control, meal credit processing, time logging for employees, printing applications, and others. The POS terminal 9 as a component of the E-POS system strategically performs a novel function of dispensing prepaid information on services and goods; collectively referred to as products, without the need of a physical prepaid card. By this application, the benefits of efficiency in terms of reduction in card production resources, manufacturing time and corresponding financial expenditures are optimized.

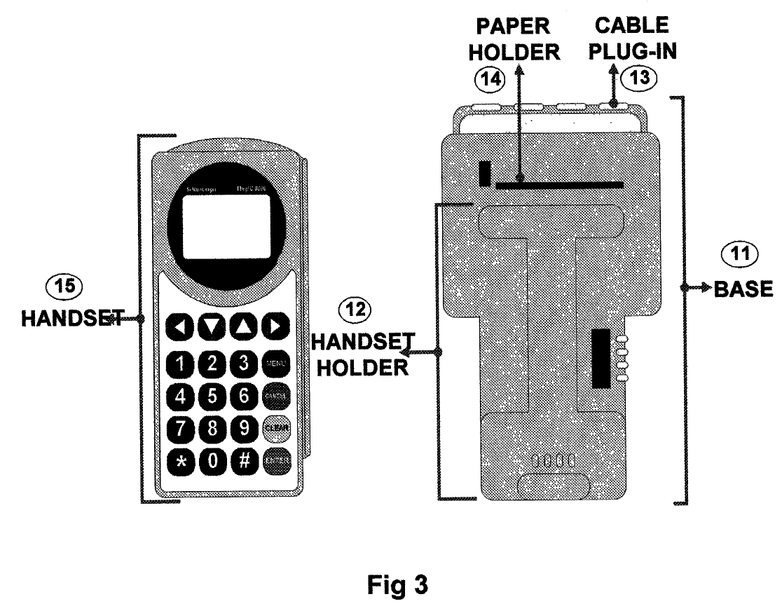

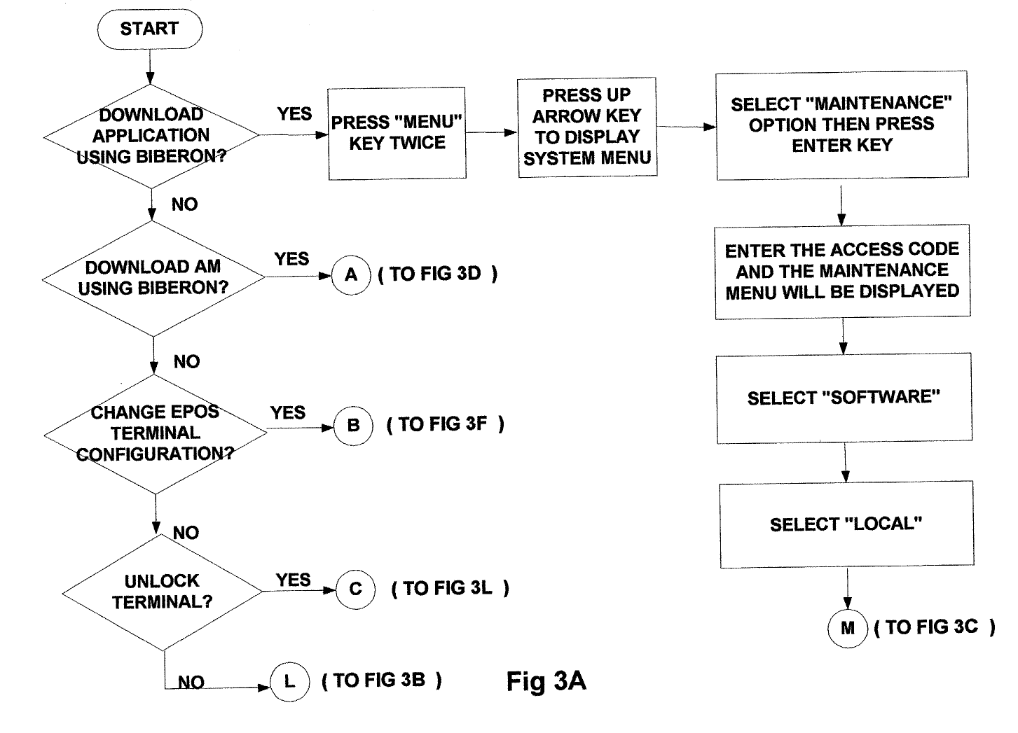

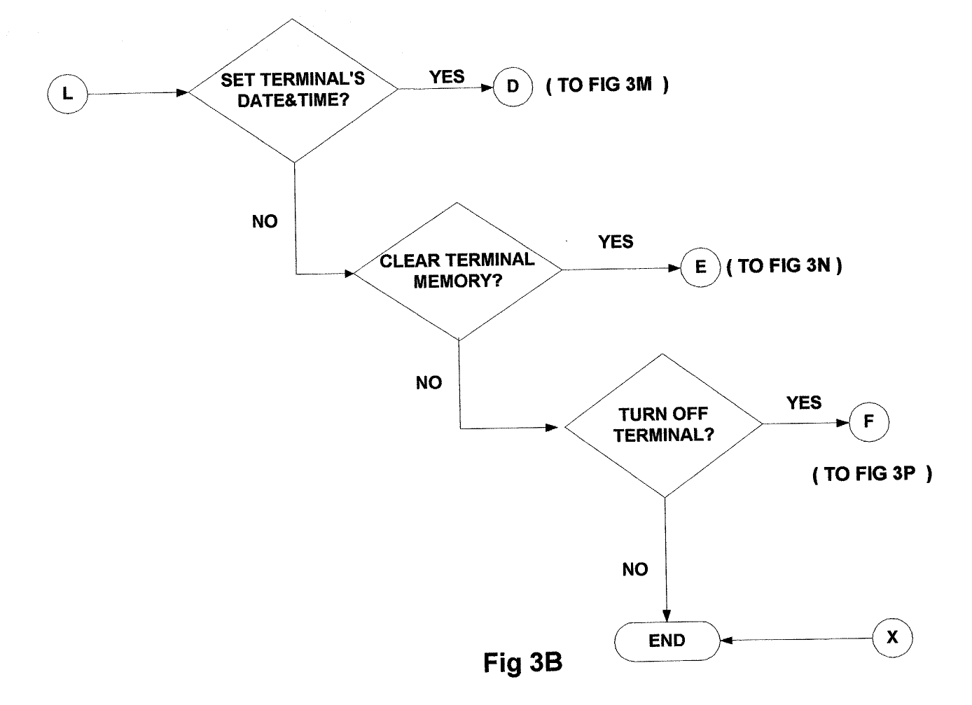

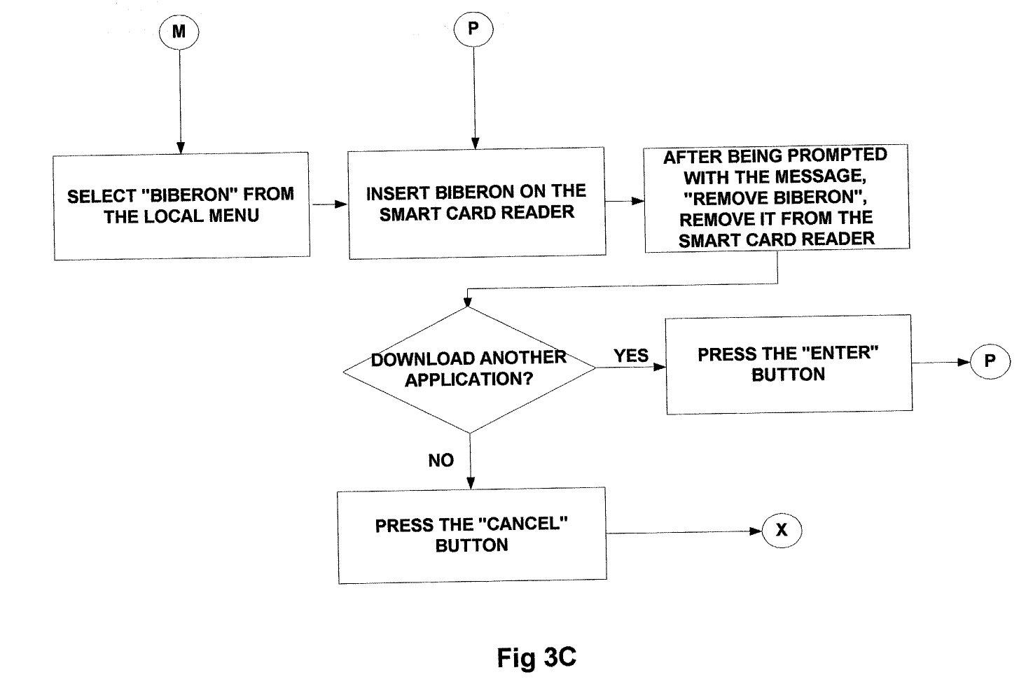

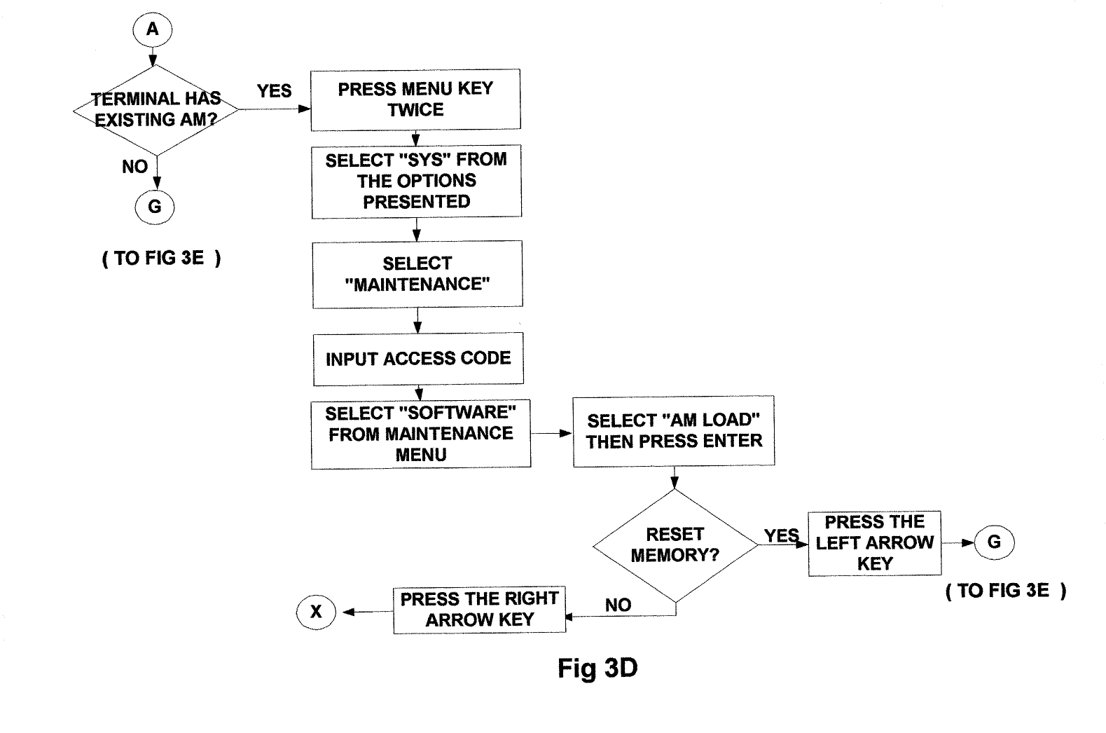

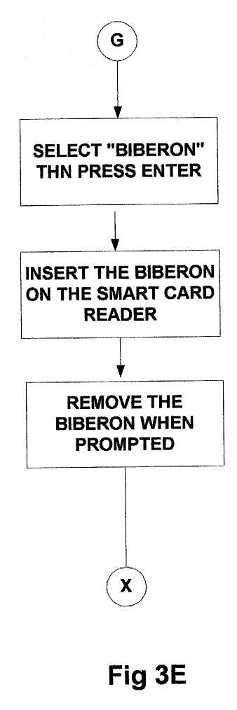

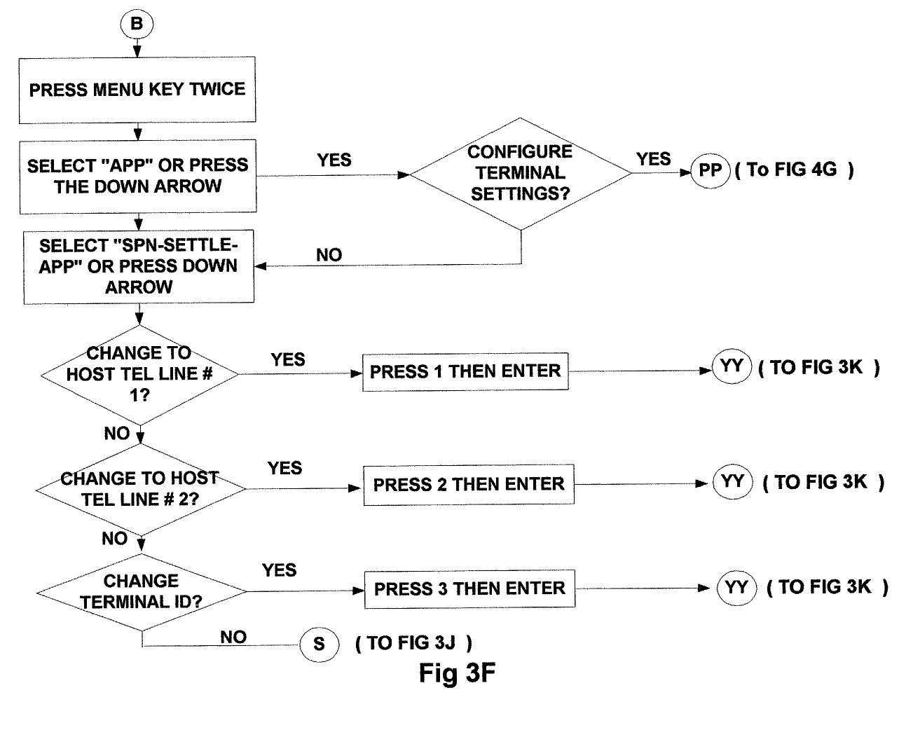

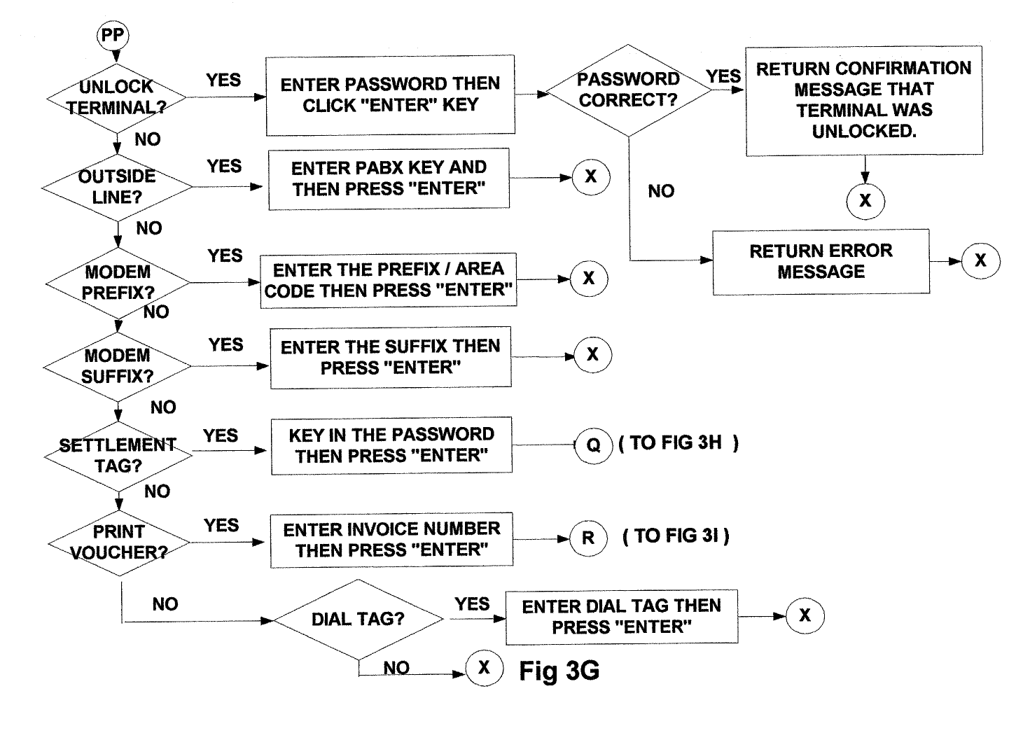

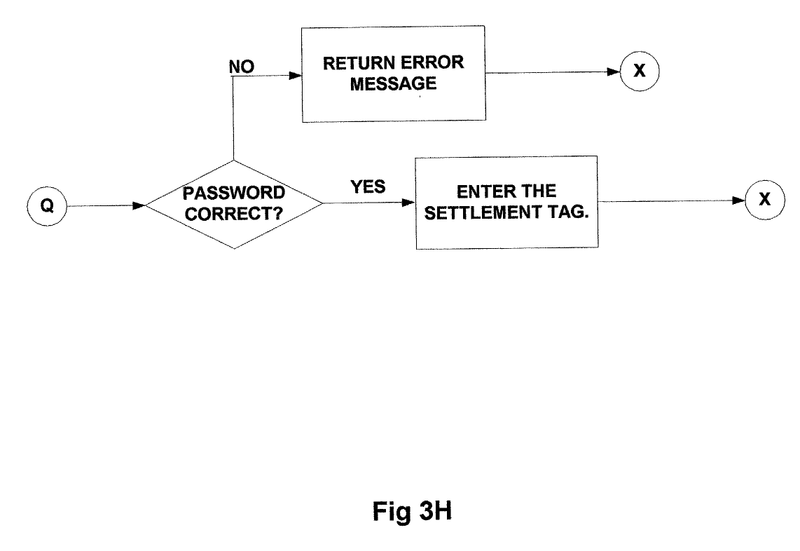

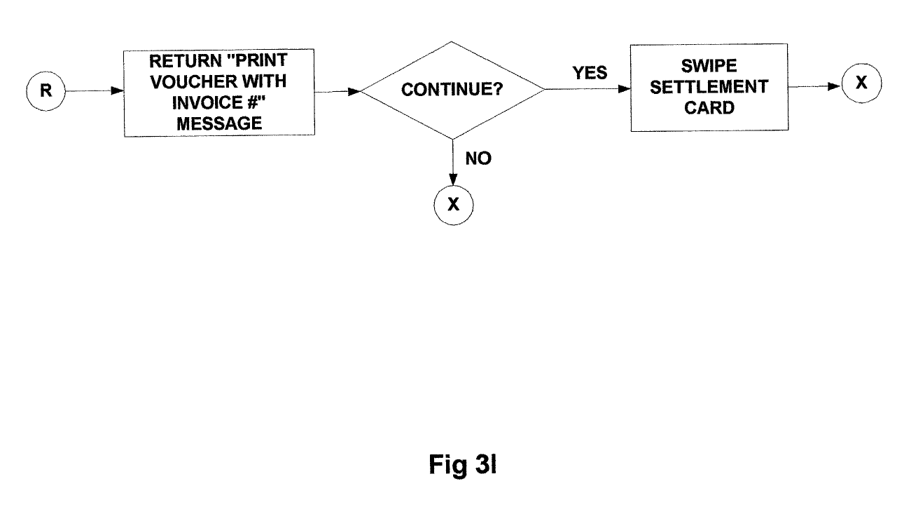

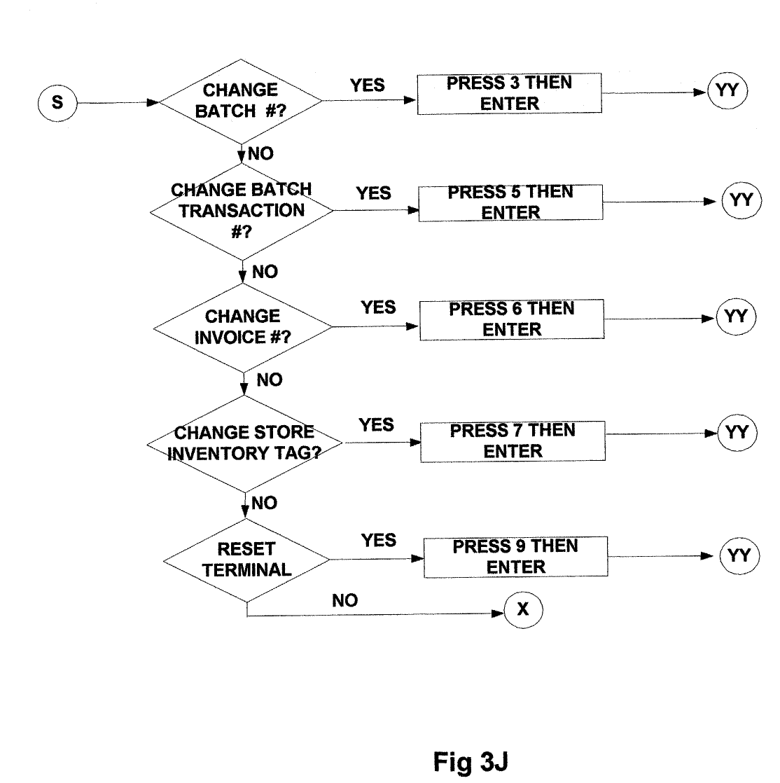

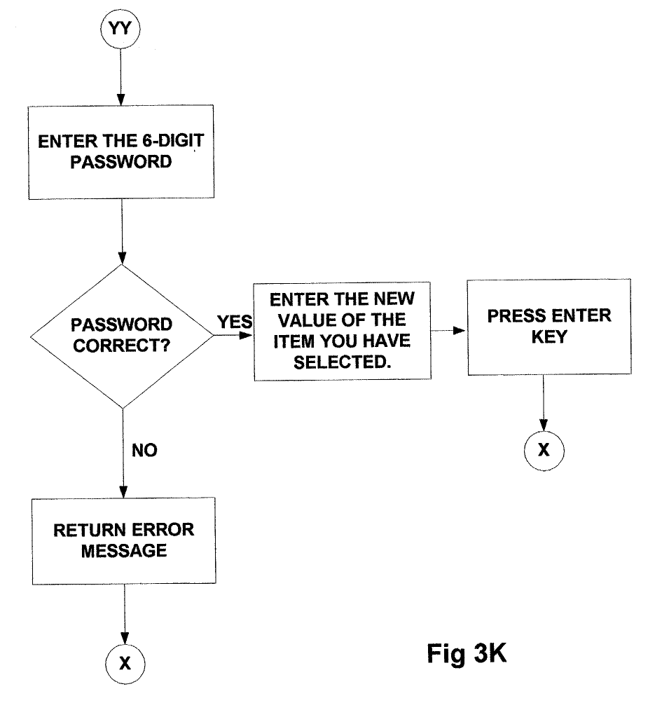

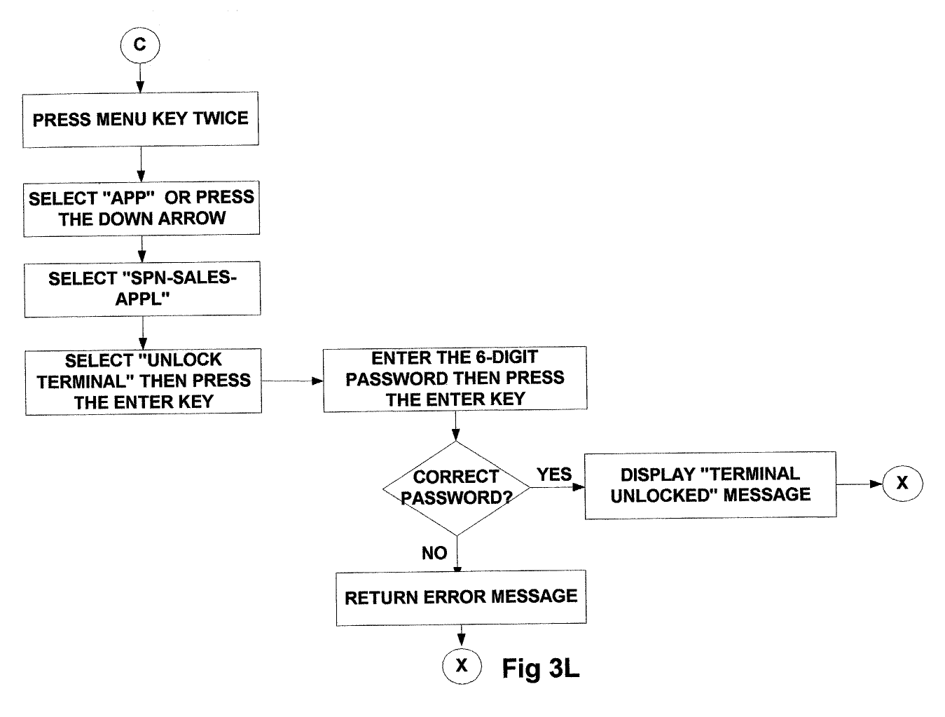

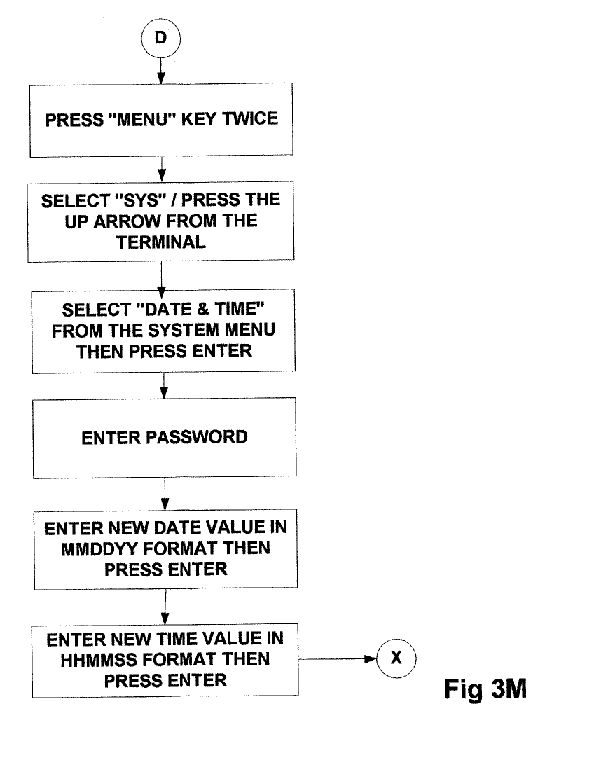

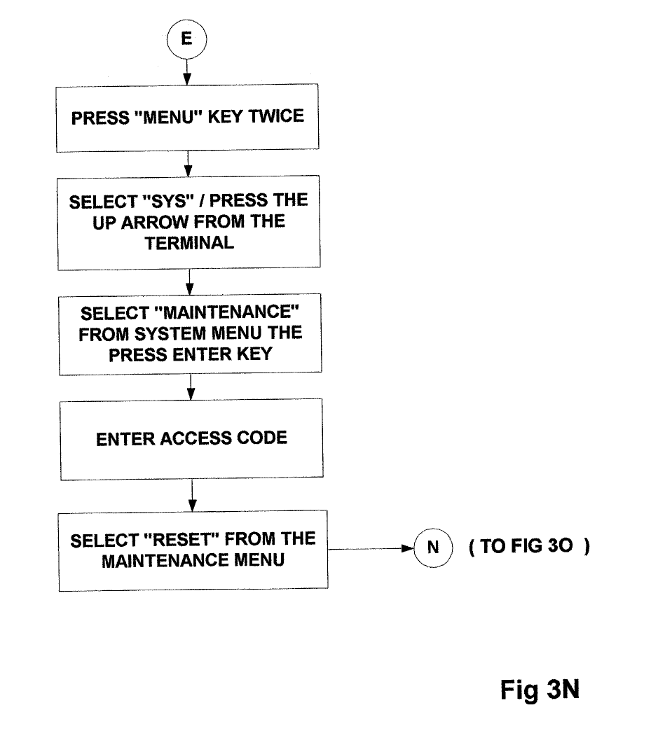

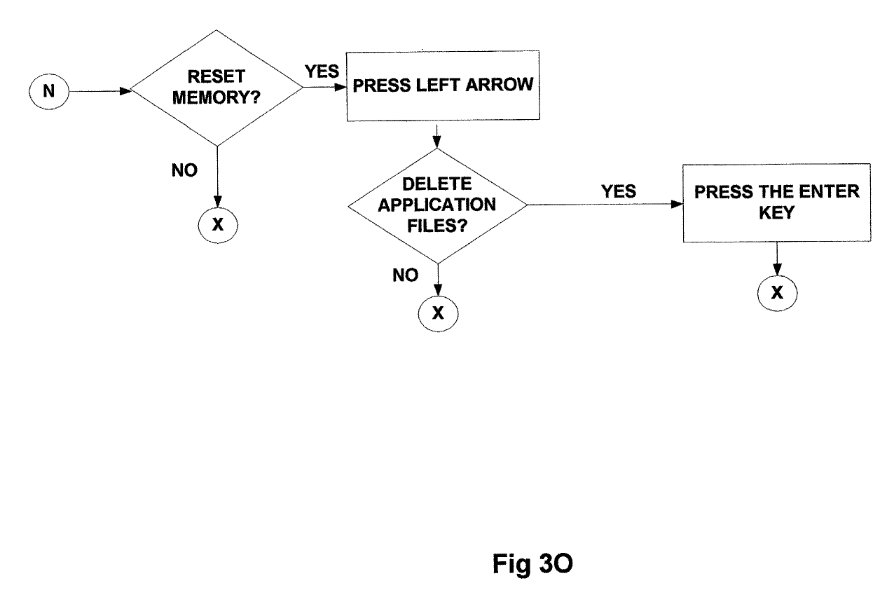

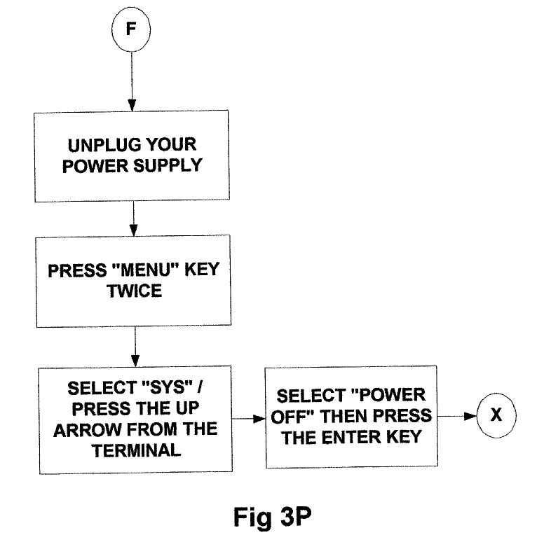

FIG. 3 clearly displays a top-view illustration of a POS terminal 9 with its basic parts. Typically, the popular models used for E-POS applications are the Schlumberger MagIC 8000, Ingenico, and Verifone. Schlumberger MagIC 8000 is chosen for the figure example and is preferred because it is tamper resistant. When one attempts to steal the POS terminal 9 and the data stored within and in the process opens the POS terminal 9 for access, the memory embedded in the terminal will automatically clear. The versatility of the E-POS system, however, is not limited to Schlumberger models alone. Rather, its compatibility and flexibility can also be extended to all kinds of POS terminal models.

An independent application software is installed in each POS terminal 9. When a new POS terminal 9 is designated for a distribution outlet, it is first brought to the E-POS system engineers for initial setup. FIGS. 3A-P shows the steps of initialization process followed by system engineers during the E-POS system installation. Initialization on a POS terminal 9 is normally only done once unless errors or malfunctions on the POS terminal 9 were detected.

During the initialization process, the following occur:

1.) The Application Manager (AM) is downloaded to the POS terminal;

2.) The POS terminal settings are configured;

3.) The POS terminal in unlocked;

4.) The POS terminal's date and time is set;

5.) The POS terminal's memory is cleared; and;

6.) The POS terminal is turned off after use.

The step-by-step occurrence of each of the terminal function is represented by flowcharts shown in FIGS. 3A-P.

The Application Manager (AM) is an application software within the POS terminal 9 coming from the supplier. This software would activate any application to be embedded on it through a Biberon Card. The Biberon card is what the developers use in initializing as well as loading programs on the POS terminals 9.

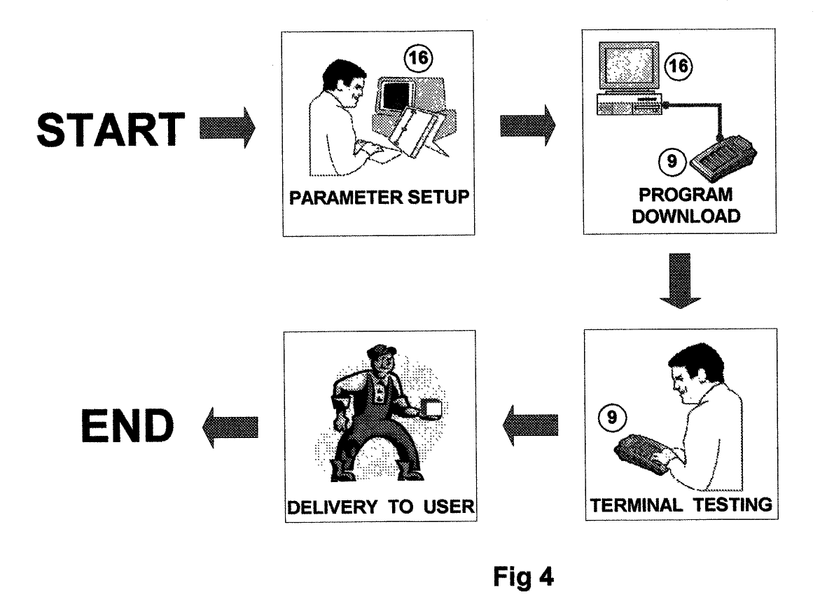

After initialization or parameter set up as shown in FIG. 4, from the E-POS Loading Terminal 16, a random password is generated exclusively by the E-POS back end system for the POS terminal 9 and this is its key to unlock it. The basic functional program for the E-POS system is downloaded unto the POS terminal 9. The E-POS Loading Terminal 16 is simply a regular computer terminal, which is designated to store the necessary data, passwords and an independent software herein, the E-POS system basic functional program for download to the POS terminal 9. It can be regarded as a separate computer from the E-POS network configuration. After receiving its download, the POS terminal 9 then undergoes standard testing for quality assurance by the E-POS system engineers before finally being delivered to the assigned distribution outlet. The standard testing involves doing the actual operation to detect any errors in the program commonly referred to as debugging the system.

The POS terminal 9, which is shown in FIG. 1, contains the memory for the basic functional program loaded into the terminal.

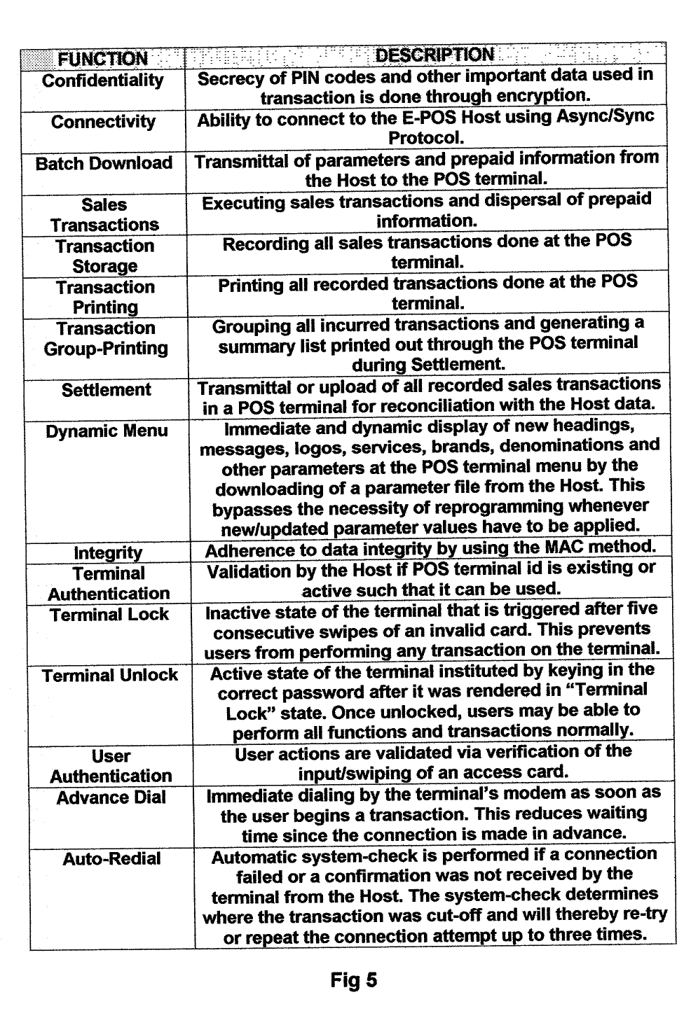

All functions within the POS terminal 9 are controlled by the basic functional program embedded in its memory. Basically, the program acts as an application that dispenses prepaid information through the POS terminal 9. The full listing of its functions are clearly enumerated in the table of FIG. 5. The most significant functions are those that primarily revolve around the Cycle for Prepaid Credit Replenishment. This comprises User Authentication, Connectivity, Batch Download, Sales Transactions, Transaction Storage, Transaction Printing and Group-Printing, Settlement, and Dynamic Menu. The rest are secondary actions in corresponding support of the primary functions. In line with all aforementioned capabilities, the program behind the POS terminal functions is designed to execute the properties of terminal authentication, confidentiality and integrity over the transaction data that is manipulated throughout the system. One example involves the Batch Download and Sales Transaction functions that are described subsequently in more detail.

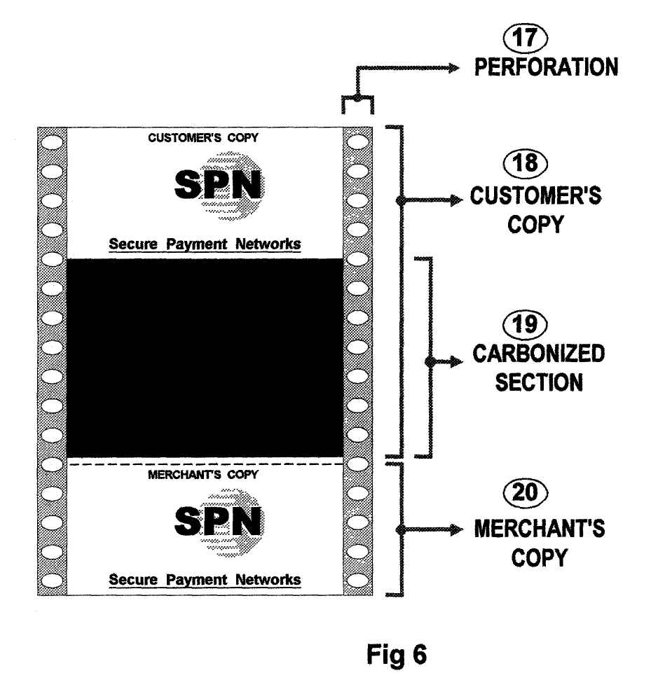

The POS terminal 9 is electronically connected to the terminal base 11 which houses the internal printer, modem and plug-ins for establishing connectivity with the E-POS Host as referenced in FIG. 3. The Cable Plug-Ins 13 are like the device sockets where phone lines are plugged to connect with the E-POS Network Communication Controller 8. A tangible media such as a paper is placed at the Paper Holder 14 for the printing function. The paper can be any paper substrate, a blank white roll of paper or a sealed paper voucher. For example, 2.25″ wide two-ply perforated paper voucher, as illustrated in FIG. 6, was designed exclusively for E-POS printing of prepaid data for Schlumberger MagIc 8000 Terminal. The sides of this paper are edged with perforations 17 for mechanical feeding into the POS terminal 9 when printing is in progress. It is divided into two sections: the Customer's Copy 18 and the Merchant's Copy 20.

Surrendered to the customer, the Customer's Copy 18 holds the carbonized section 19 where the prepaid key codes (PIN and Card Number) along with the matching Serial Number and some sales transaction data are printed. Being two-ply, both longitudinal sides of the paper roll are glued to make them stick to each other prior to printing. After the prepaid information has been printed out, customers simply peel off the cover or top sheet to read the prepaid information hidden by the carbonized section area of the second sheet. Once read and stored, recorded or memorized, the Customer's copy 18 can be discarded after tearing or shredding to prevent another from getting the hidden information.

Meanwhile, the Merchant's Copy 20, kept by the dealer or store owner, would contain the sales transaction data and Serial Number of the prepaid information that was printed out. Accumulated throughout a day, the dealer may use these copies to crosscheck against the sales transactions of the grouped summary list printed out during settlement at day's end. The merchant can discard the merchant copies after settlement or recording.

The carbonized substrate design behind the sealed paper voucher incorporated into the E-POS system is also a novel aspect of this invention that is specifically designed for the sales transactions involving the dispersal of downloaded prepaid information from the POS terminals. The company that produces this sealed paper voucher for this E-POS system is Advance Computer Forms, Inc., M. Bartolome Street, Barangay 163, District 4, Sta. Quiteria Extension, Caloocan City, Metro Manila, Philippines. The terminal also has a handset part 15, which may be mounted or detached from the handset holder as needed.

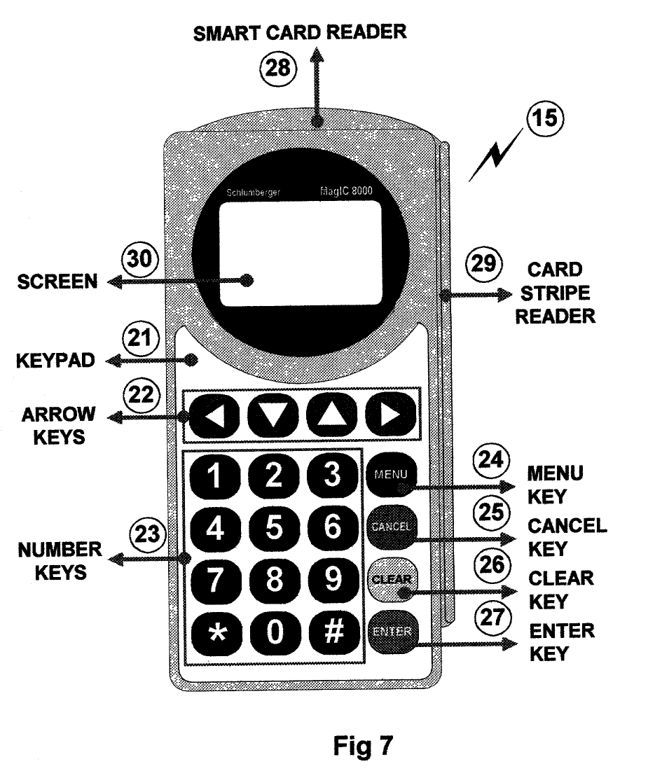

Shown in more detail at FIG. 7, is the handset 15 which serves as the user-interface portion of the entire POS terminal 9 via its simple keypad 21 for receiving operator commands and access card entry. Arrow Keys 22, Number Keys 23, a Menu Key 24, a Cancel Key 25, a Clear Key 26 and an Enter Key 27 are the buttons within the keypad 21 that prompt the terminal user for any command or data entry. The Smart Card Reader 28, located at its top, is for reading parameters from access card with embedded Smart chips. On the other hand, the Card Stripe Reader 29, located at the handset's right side, is for reading parameters from access cards manufactured with magnetic stripes. By either entry, the POS terminal 9 verifies the encoded parameters to activate the particular function/transaction desired by the terminal user. The handset's screen 30 in turn displays all menu options, headings, logos, text advertisements, messages and other significant parameters to the POS terminal user.

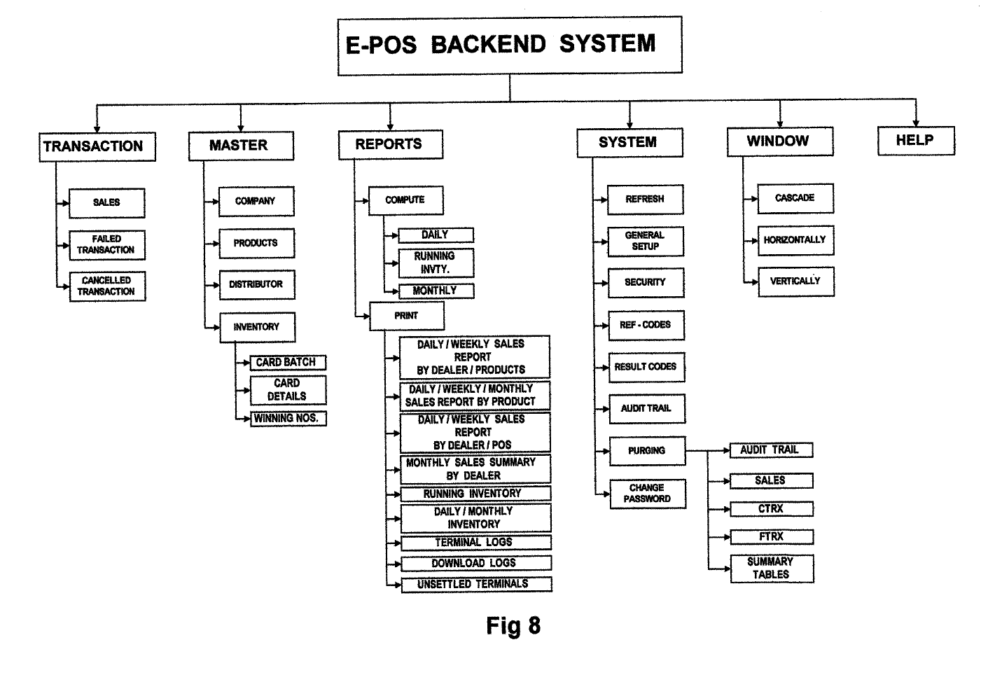

The E-POS Back-End System, a program residing within the Application Server 4, is a novel component of the E-POS system proposed by the invention. Its primary purpose is to maintain the database of parameters which refer to data to be used in the transaction such as prepaid pins, card numbers, passwords, etc., distributors, dealers, product inventories and transactions. It likewise provides management, inventory reports and system utility functions. Access and usage of the Back-End System, however, is limited to assigned E-POS administration users only. These are the officers who will coordinate regularly with the telecommunication companies, accredited distributors, dealers, and the other assigned POS terminal users. The chart represented in FIG. 8 displays the terminal user modules of the Back-End System. In summary, the major consolidated functions of its modules are as follows:

1. POS Management—New POS configurations and modifications are done through this system. Updates to products and denomination may be done without having to change the POS program For example, if user M1 wants to introduce a new value card, this will not require any change in program but a simple update of the POS parameter file on the next time it does settlement and the new denomination is available. Message and header information are also entered through this system

2. Terminal User Access—Each POS terminal user will be required to have an access card, which must be swiped on the POS terminal before each transaction. The E-POS Back-End System manages the creation and maintenance of user access to POS terminals as well as to system web reports. System web reports are limited to the reports that are produced/shown via the website.

3. Database Management—Aside from the basic maintenance function on all data and transaction files, the utility actions of purging, backup, restore and cleanup on the E-POS database are exercised on a relevant basis.

4. Importation of Prepaid PIN Numbers—This facility handles the importation of different formats of Personal Identification Numbers or PINs sent from the accredited distributors. Accredited distributors produce a request from end customers usually containing prepaid values (i.e. PINS, Card Numbers, etc.) and immediately send this an encrypted text format to the Web Server 3 onto the distributor's respective FTP or File Transfer Protocol sites. Once sent, the distributors immediately alert the E-POS engineers to confirm the receipt of data and load them unto the Application Server 4 temporarily to execute the process of decrypting and converting the key parameters into the correct database format. The data is then imported into the main database at the Database Server 2 for operational availability.

5. Report Management—Significant system reports are managed and retrieved by the Back-End system. They may be printed out for tracking, evaluation or filing purposes. They are as follows:

Sales Transaction Register

Settlement Report

Rejected Transactions Report

Daily Sales Report by Dealer/Product

Weekly Sales Report by Dealer/Product

Daily Sales Report by Product

Weekly Sales Report

Daily Sales Report

Weekly Sales Report

Monthly Sales Summary by Dealer

Terminal Logs

Unsettled Terminal List

Audit Trails

E-POS also provides a separate set of system reports for the exclusive use of its accredited distributors/dealers. These other reports may be accessed through the Fully Qualified Domain Name (FQDL) that is set up or linked at the E-POS system web server. Each accredited distributor/dealer will have the option to create a new domain for the E-POS web server or link to the E-POS web server from their own existing website provided that the customer web server has a valid ISP IP address.

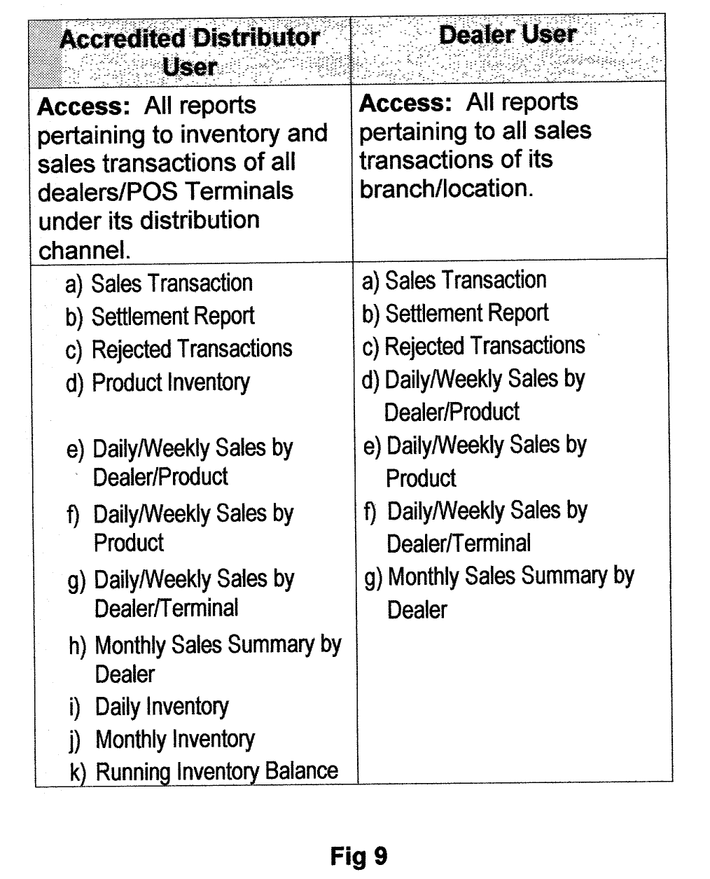

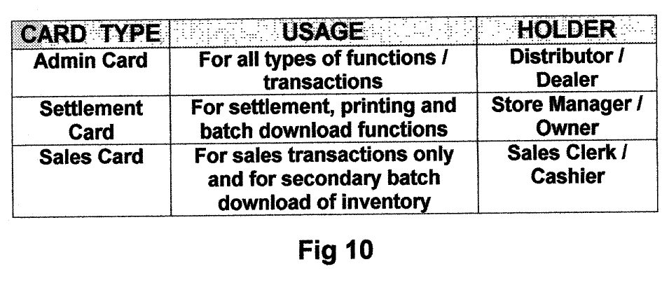

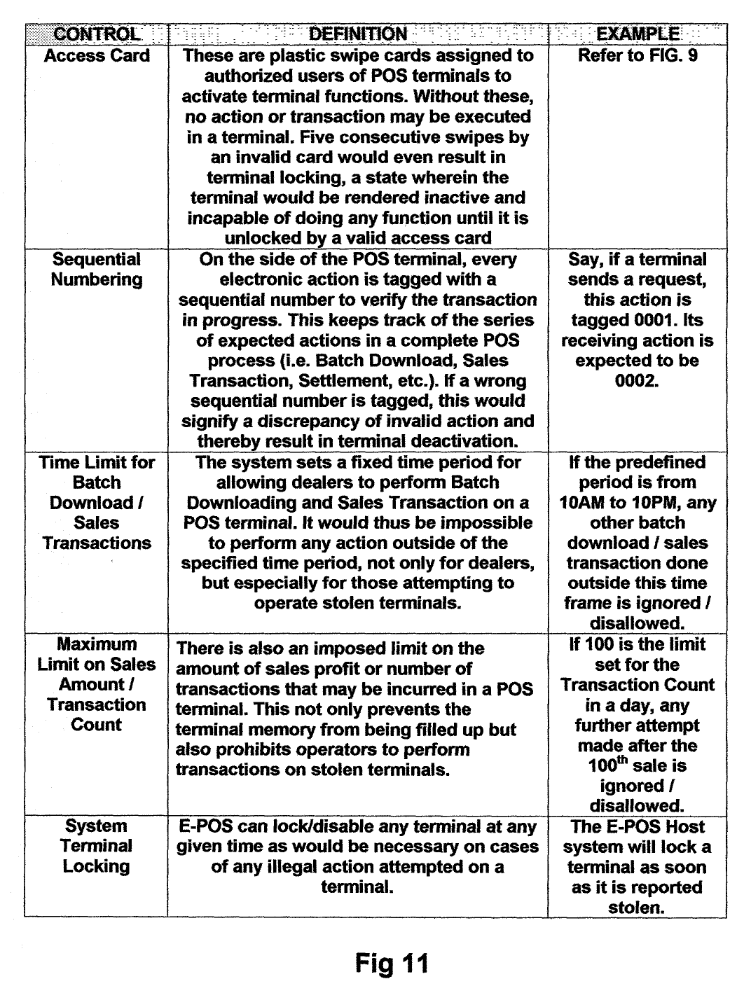

FIG. 9 enumerates the list of web reports accessible to the distributors and dealers affiliated with the E-POS system As implied by their categorization, Distributors Users may print reports pertaining to inventory and sales transactions based on dealers or POS terminals under their distribution channel. Dealer Users, on the other hand, may print the reports pertaining to all sales transactions of their respective branch/location. The given domain verifies the terminal user through a security login module before allowing access to the reports. On the event that some difficulty or technical problems are encountered while accessing the given domain, distributors/dealers may contact the assigned operators of the Back-End System to request for copies of the particular reports they currently need. This is a temporary contingency measure offered by E-POS since the Back-End System generates the complete set of reports accessed by both distributors and dealers through the web.

Prepaid credit replenishment is initiated by swiping a valid access card on a POS terminal 9 to activate it. An access card 31 appears similar to a credit card and has a magnetic stripe across its back or a Smart electronic chip embedded at its front. The Terminal User ID Number of an access card is randomly generated while the Card Number is sequentially generated by the E-POS database. Apart from these, its security level is also indicated at the database to define its set of privileges (be it for Admin, Settlement or Sales Transactions). The Terminal User ID is encoded unto the magnetic stripe or Smart chip of the card while the Card Number is printed at its front for the holder to identify with.

The table in FIG. 10 enumerates the valid types of access cards for the E-POS system. The Admin Card holds the highest of all privileges and should be carefully assigned to authorized distributors/dealers of E-POS system products. Though they may activate all POS terminal functions (from batch downloading to settlement), their use must be reserved for emergency or contingency reasons. For example, if the Sales Card of a clerk is stolen/lost/damaged, the Admin Card of the accredited distributor or dealer may then be used to minister sales transactions on the terminals for a temporary period until a new Sales Card becomes available.

Settlement Cards are used for batch downloading, printing and settlement functions. They are meant for the store managers or owners to monitor and operate the major terminal transactions dealing with volumes/batches of transaction data. Sales Cards, on the other hand, only activate sales transactions and secondary batch downloading on terminals. They are typically given to sales clerks or cashiers who handle the ministering of singular sales transactions repeatedly per working day.

The other security and control measures exercised by the E-POS system are well summarized in the table of FIG. 11.

A distributor wanting to use the E-POS system initially purchases e-PINs (electronic PINs) for usage by dealers and transfer these to their respective File Transfer Protocol sites. Once sent, the distributors immediately alert the E-POS engineers to confirm the receipt of data. The engineers retrieve the distributor's data and load them unto the Application Server 4 temporarily to execute the process of decrypting and converting the key parameters into the correct database format. The data is then imported into the main database at the Database Server 2 for operational availability. This step is also part of the initialization of the system described earlier.

The system, after initialization of the E-POS system delivered to all accredited distributors or dealers described above, is ready to perform prepaid product dispensing and replenishment, with or without the use of a tangible prepaid card.

The process for dispensing prepaid product or prepaid credit replenishment using an E-POS system comprises activating the initialized POS terminal 9, transmitting an encrypted request from a customer to a Host Server 1 from a POS terminal 9 through a concentrator 8 by the user, retrieving and loading the encrypted customer request to an Application Server 4, the Application Server 4 temporarily decrypting and converting the request into a correct database format for storage into the database, validating a user the request received from the POS terminal 9 by the Host Server 1 through information stored into a database, conveying the validated user request to the requesting POS terminal 9, processing the validated user request by the POS terminal 9 and dispensing the prepaid product user request to the customer.

The user request received from the POS terminal 9 is validated by authenticating that the packet format at the POS terminal 9 exists and is active on the packet format of the Host Server 1. The validation comprises the matching of packet formats between the POS terminal 9 and the Host Server 1. The packet formats include the category, brand, model of the product and the type of sales transaction.

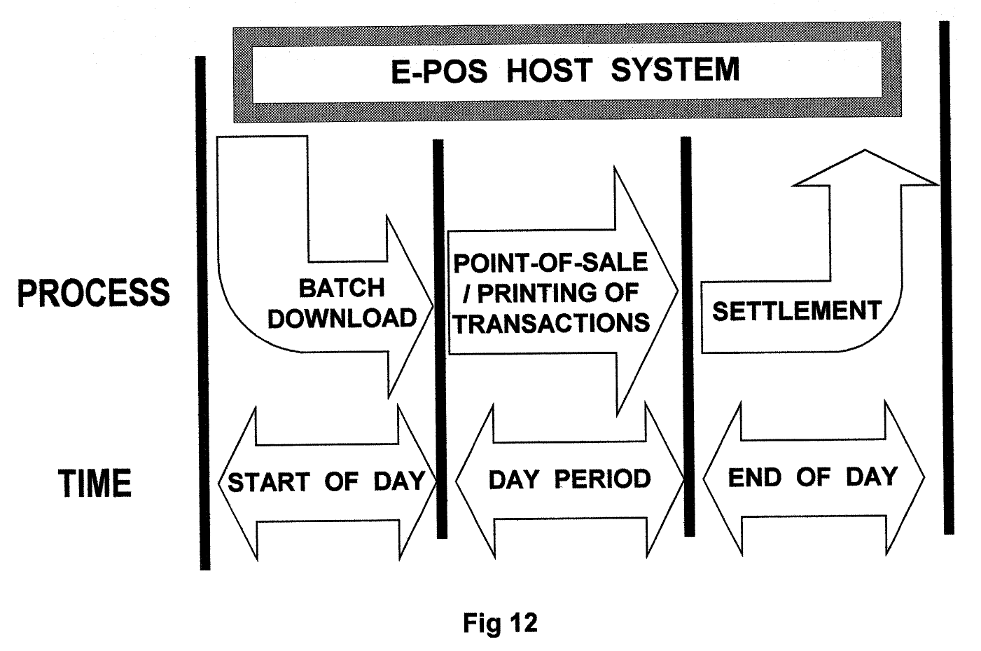

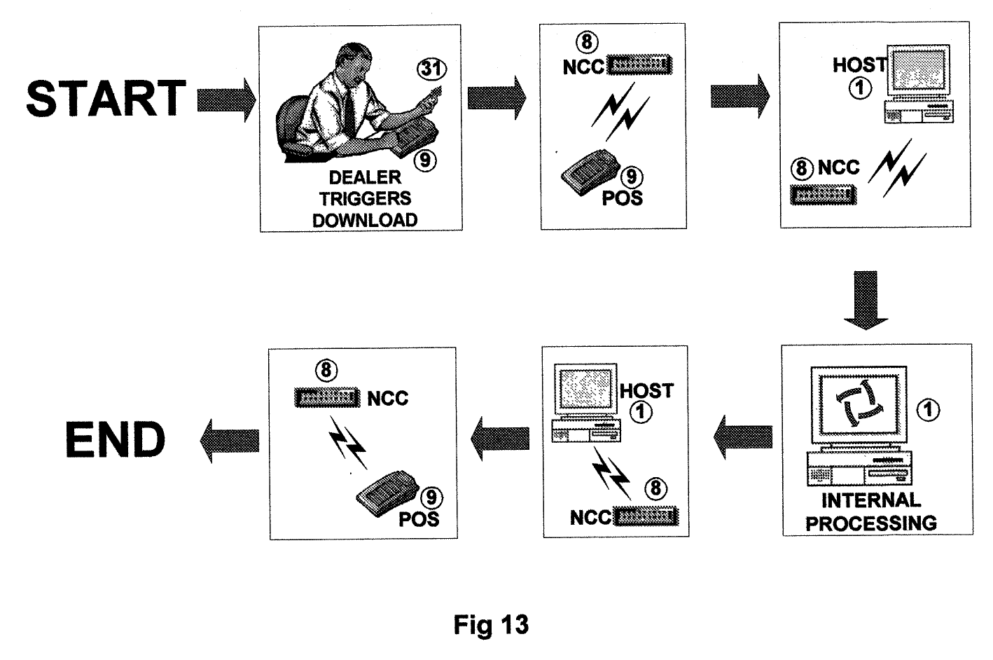

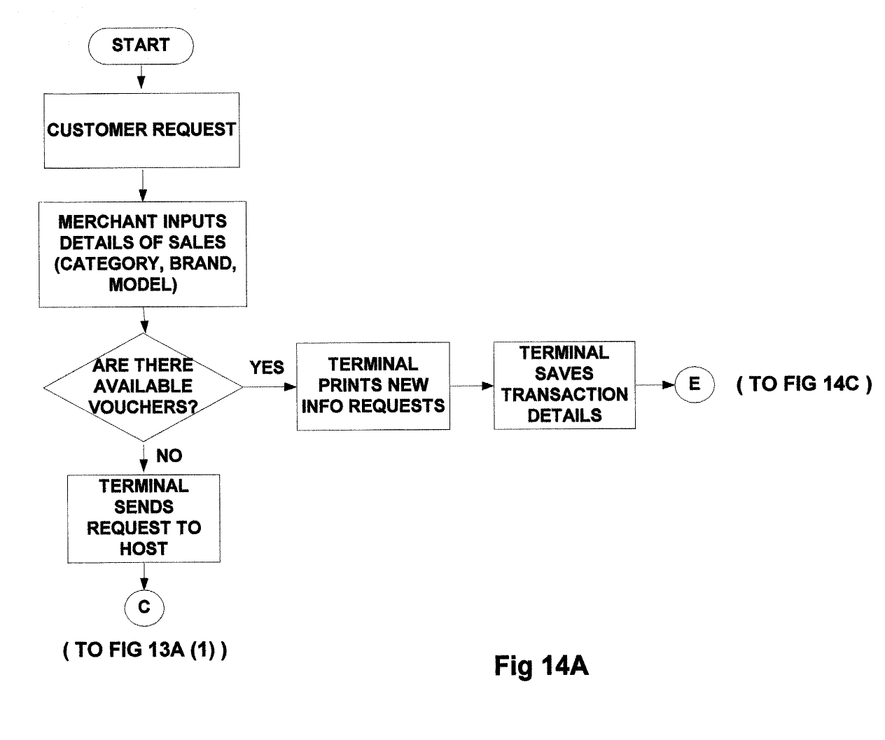

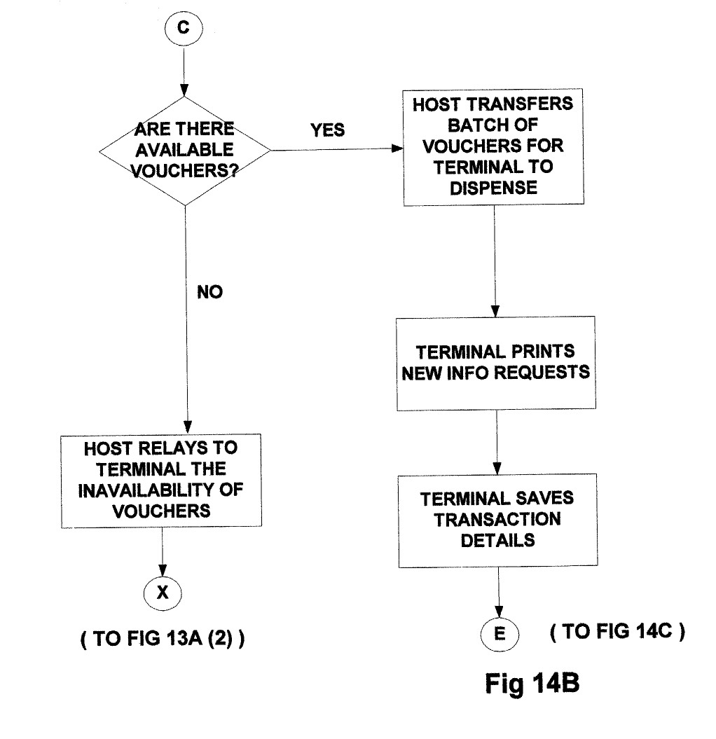

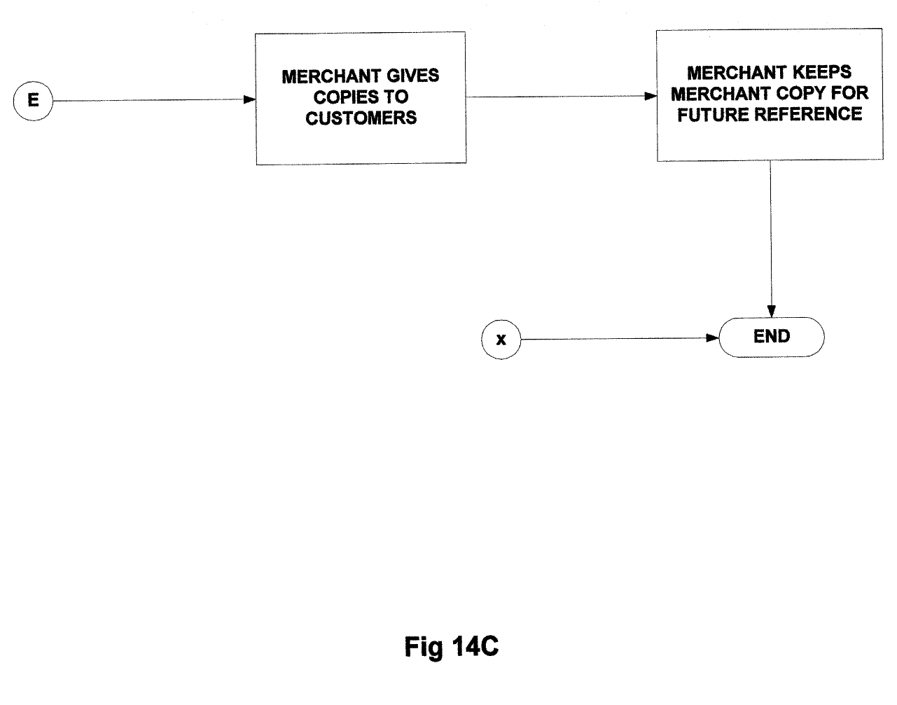

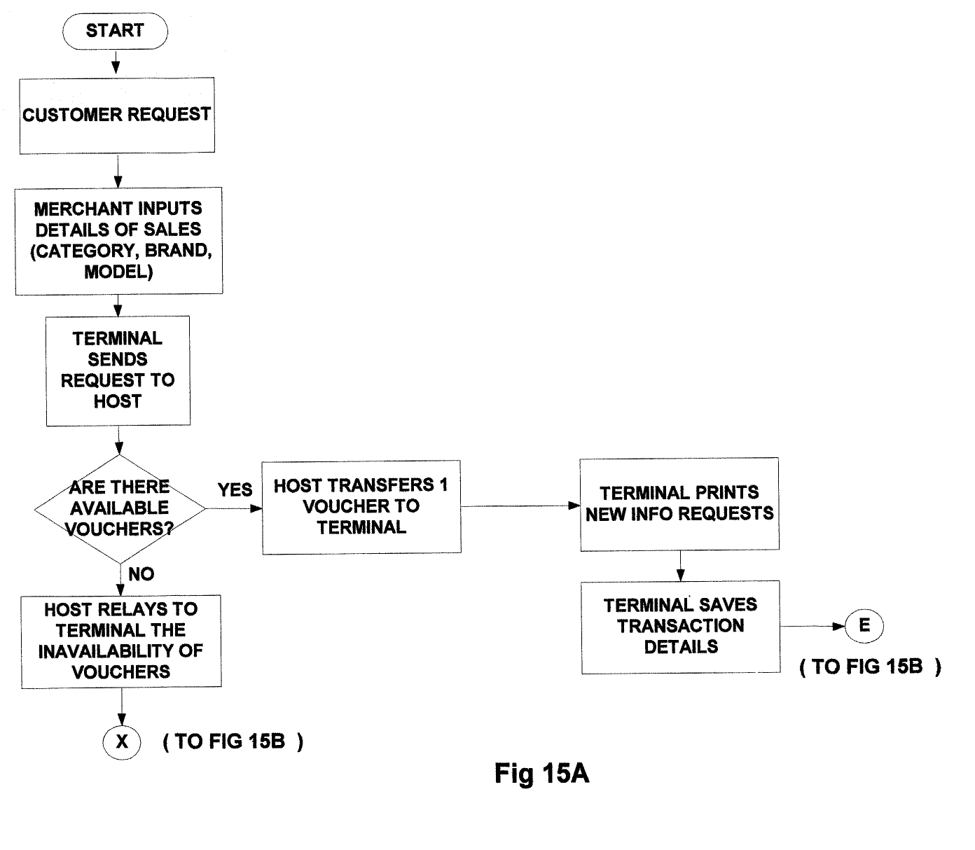

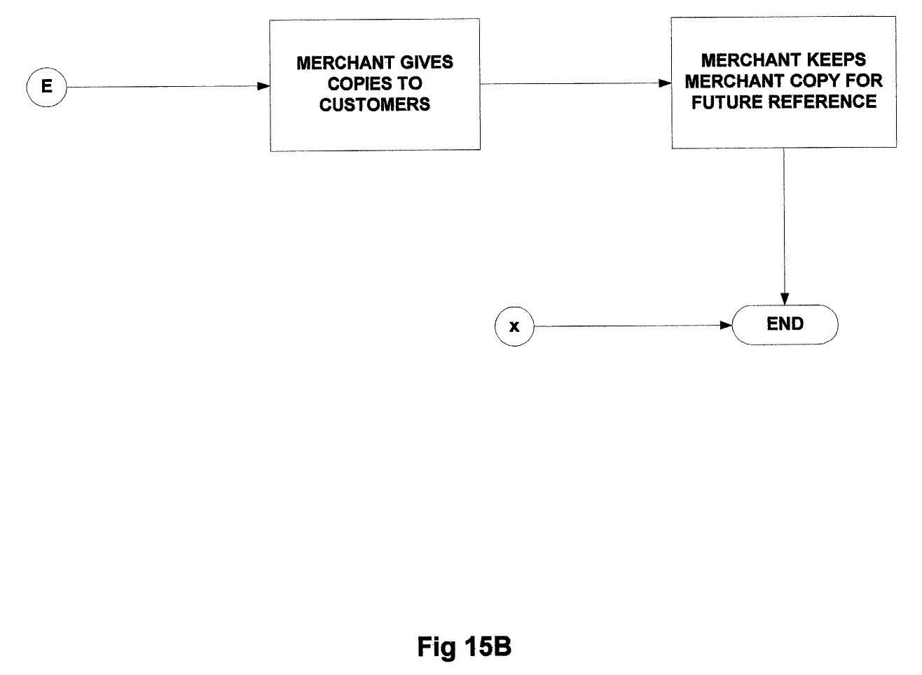

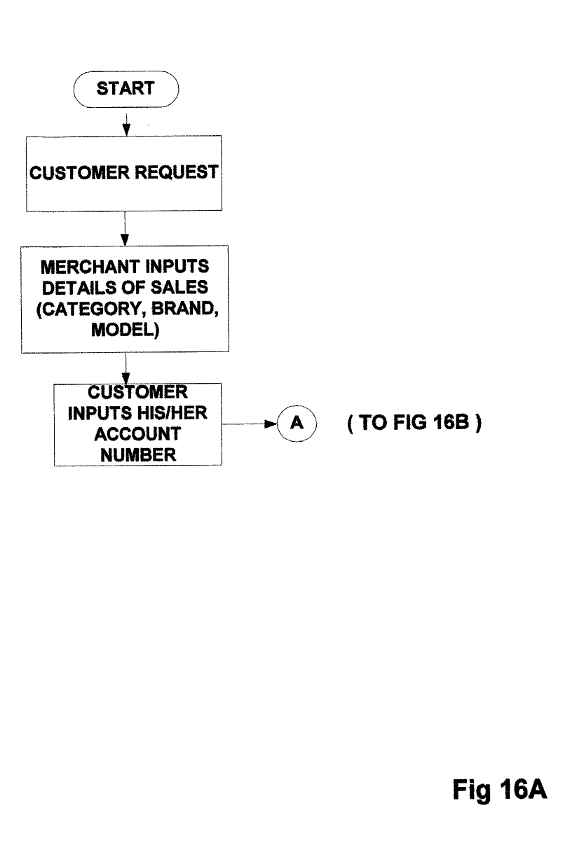

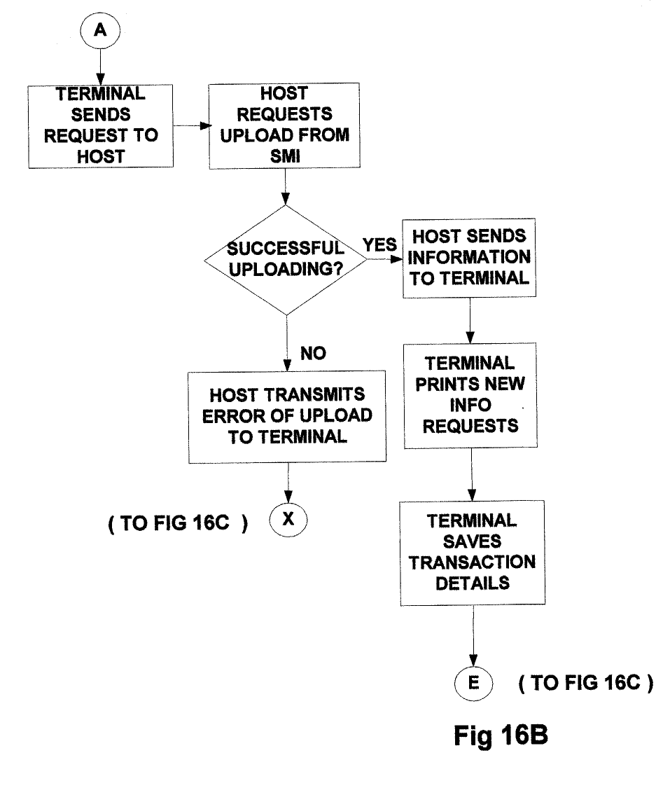

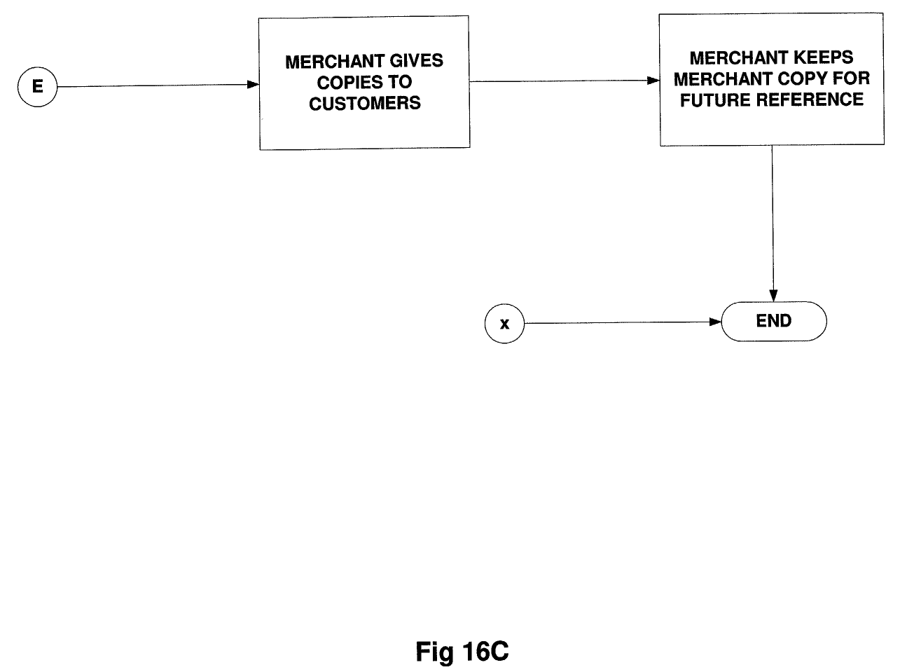

FIG. 12 illustrates the general steps undertaken by the E-POS Host System on a normal sale transaction with a customer in need of a prepaid product or a prepaid credit replenishment using Batch Downloading. At the start of a working day, an initial Batch Download process is performed for POS terminals 9 that store parameters and inventories. This is the function that retrieves sets of significant parameters or sale vouchers i.e. prepaid pins, card numbers, passwords, etc., and inventory from the Host Server 1 in terms of quantity for downloading into the POS terminal memory which is initially empty. The quantity depends on the number of units that was set on the Host Server 1. Initial Batch Downloading is done prior to performing Batch Downloading sales transactions using the initiated POS terminals 9 storing inventories. Initial Batch Downloading as shown in FIG. 13 is done by choosing the “Batch Download” option from the POS terminal 9 after the POS terminal 9 has been initiated. The terminal will then establish a connection to the concentrator, herein illustrated by a Network Communication Controller or NCC 8 up to the Host Server 1. The Host Server 1 acts as the middleware for the applications that acknowledge all incoming requests from the Network Communication Controller 8. It then retrieves the necessary transaction data for example data sets of inventory such as denominations available for a given service by a provider, from the Database Server 2 and conveys these validated data or information back to the Network Communication Controller 8 for download to the requesting POS terminal 9. After the Initial Batch Download, the E-POS system is now ready to perform sales transactions as shown in FIGS. 14-16. FIGS. 14A-C show sales transaction by the batch downloading method. FIGS. 15A-B show sales transaction by Instantaneous Batch Downloading method. FIGS. 16A-C show sales transaction by top-up method. The sales procedure starts with a customer request such as for a sale voucher. The sale voucher, which details the PIN given by the telecommunication company, nature and amount of the prepaid products purchased, can be obtained by several ways. If the POS terminal 9 is one that stores inventory obtained from the Host Server 1, the system performs Batch Downloading. The users input details of the sales voucher (Category, Brand, Model such as sale type, pay type, print/void action, amount, etc.) at the POS terminal 9 which checks if it has the customer's request. If it has, the POS terminal 9 dispenses the customer request and the customer renders payment upon receipt. For POS terminals 9 that do not store inventory but disposes only one sale voucher at a time, after the user inputs the details of the sales request by the customer, the Host Server 1 transfers the sale voucher for that particular user request for dispensing to the customer through the POS terminal 9. This is referred to as the Cycle for Prepaid Credit Replenishment with Instantaneous Batch Downloading or simply Instantaneous Batch Downloading.

In the Instantaneous Batch Downloading, the prepaid data must be fetched from the Host Server 1 and downloaded into the POS terminal 9 during every sales transaction. For this case, the types of POS terminals in use need not possess large memory sizes to store batches of inventory data throughout the day. In addition, security is more implicated since the prepaid data comes into availability only during and after a sales transaction rather than before it. Worthy of mention is the fact that the Host Server 1 within the system dictates whether a POS terminal 9 requires Batch Downloading or Instantaneous Batch Downloading based on the type of the terminal used.

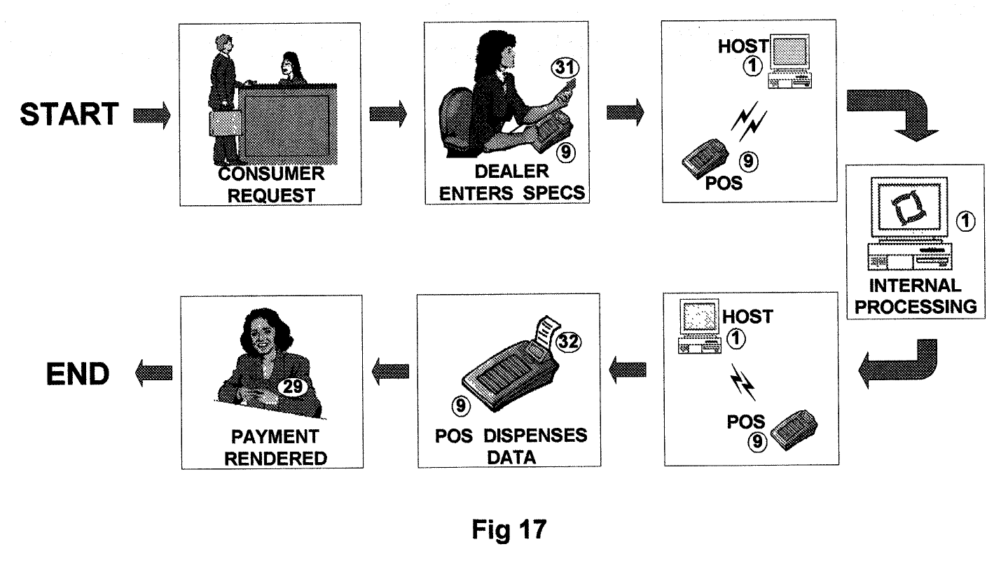

A typical sales transaction with instantaneous downloading under this particular cycle is represented in FIG. 17. Customers in need approach the available outlets to request for a sale voucher for prepaid product or credit replenishment. They indicate their preferences and particulars for purchase. The dealer/user initiates the transaction by first swiping the access card 31 on the POS terminal 9 and keying in the Sale transaction option. From here, the dealer inputs the customer's request for sale voucher, prepaid product or credit replenishment specifications (i.e. category, brand, model, sale type, pay type, print/void action). The POS terminal 9 transmits the given inputs to the Host Server 1 through a concentrator, herein a the Network Communication Controller 8. The Host Server 1 gets the next prepaid data set in line conforming to the customer's sale voucher request and consequently downloads it to the requesting POS terminal 9 through the Network Communication Controller 8. After receiving the downloaded data, the POS terminal 9 dispenses the corresponding customer request on a tangible media, preferably a sealed paper voucher printout 32 to the customer. Upon receipt of the sealed paper voucher printout 32, the customer then renders payment 33 to the dealer.

The customer request such as a sale voucher can also be dispensed by uploading. Uploading is done by what is referred to as Top-up transaction. A Top-Up transaction, unlike the batch download requires that customers acquire prepaid accounts with telecommunication companies to use this system for their sales transactions. It is also imperative for some telecommunication companies to have Service Management Interface (SMI) Host be setup at the designated telecommunication company in order to interface with the Host Server 1 of the E-POS system. By this connection, user requests may be relayed between the two hosts, SMI and Host Server 1, for automatic addition of customer's request to the customer's prepaid account.

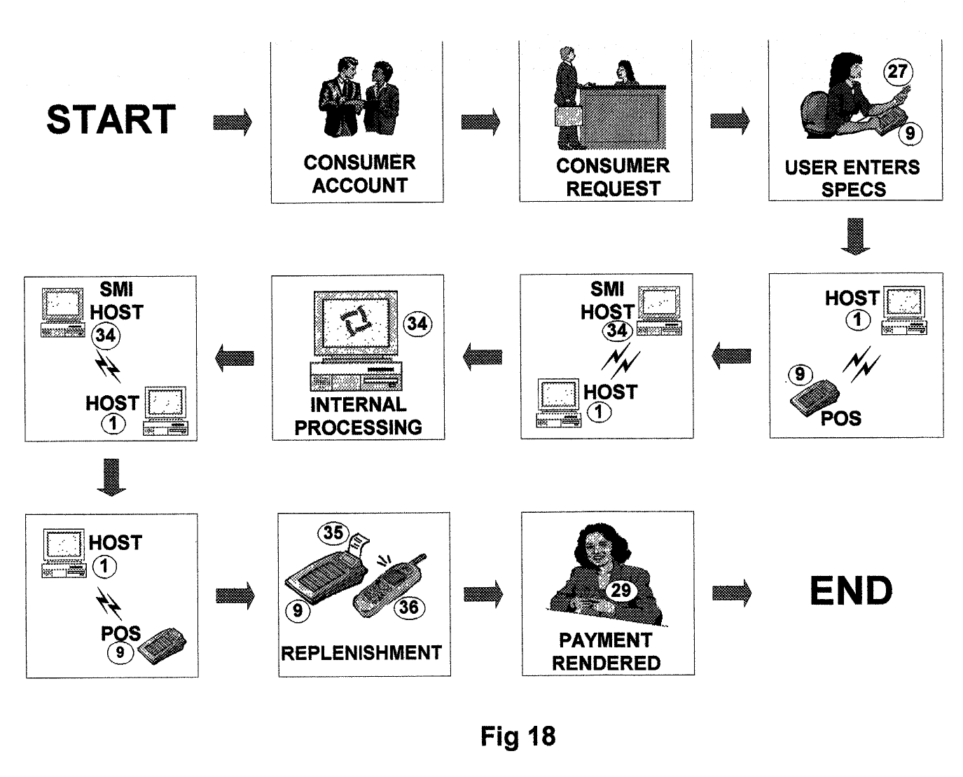

As shown in FIG. 18, it is necessary first for customers to acquire their individual prepaid accounts directly with telecommunication companies before anything else. Once established, customers may then place their requests for a sale voucher, a prepaid product or credit replenishment at accredited dealer outlets. Dealers/users swipe in their access card 31 followed by the customer swiping/keying in his or her given account number to identify which account will receive the prepaid product or credit replenishment or sale voucher. The user then inputs the customer's request at the POS terminal 9. The POS terminal 9 transmits the given inputs to the Host Server 1 through the concentrator, Network Communication Controller 8. The Host Server 1, in effect, relays the user request to the Service Management Interface Host 34 of the corresponding telecommunication company. Once received, the Service Management Interface Host 34 adds the user's request to the specified customer prepaid account number. It then sends a successful confirmation back to the E-POS Host Server 1, which relays it to the POS terminal 9 in transaction. From here, the POS terminal 9 prints out on a tangible media, the new balance and receipt 35 of the sales transaction to the customer. Every customer is encouraged to then check the updated balance through his/her mobile phone 36. When all is accounted for, the customer lastly renders payment 33 to the dealer.

When the Host Server 1 runs out of inventory, this is communicated to the POS terminal 9. A Host Server 1 can replenish inventory by a transfer from the telecommunication company. In contrast, if the POS terminal 9 that stores parameters and inventory runs out of inventory, the terminal performs a Secondary Batch Downloading.

The steps for the process are the same as that of Initial Batch Downloading. A secondary batch downloading is done only when any one of the previously downloaded inventory was entirely consumed or sold out during the course of a working day. Therefore this type of downloading is done on a product/brand/or model basis depending on what item needs to be replaced compared to the Initial Batch downloading where all product/brand/or model allocated for a terminal are downloaded initially.

When a batch download is unsuccessful or incomplete, the terminal will try to connect again (up to three times). Its menu will continually display the option for download retry. However, if batch download is successful, the menu will reflect this status and no longer display the option for download retry on the following swipe transactions.

Batch Downloading is a commonly used methodology in the E-POS system. It provides swift turnaround time during sales transactions because the prepaid data has already been downloaded into the terminal memory. Dispersal of the prepaid data to customers can therefore take a matter of seconds. It is necessary, however, that the POS terminal in use must be of a type possessing sufficient memory size to store the volume of inventory data from batch downloading.

In all these transactions, if successful, a customer is given a receipt; a blank paper or a sealed paper voucher containing the information or data on the purchased prepaid service and payment is then received from the customer. The receipts are printed by the internal printer in the POS terminal 9 using the paper substrate held by the paper holder 14 perched on the top surface of the terminal base 11. For Top-Up transactions, use of a white roll of paper or roll of plain paper is sufficient because no secret information or codes are contained in the receipt.

One of the advantages offered by the E-POS System is the capability of settling the accounts on an on-going basis, which is accessible to the accredited distributors and dealers and the ability to introduce new products or delete old product without the need of reprogramming, reinitialization, collection, upgrading and redistribution of the POS terminals 9.

The settlement process is generally performed last (or as needed) regardless of the type of point-of-sale transaction method. This function transmits back all inventory data and sales transactions incurred by the POS terminal 9. During settlement, the dealer or storeowner first swipes in the access card 31 on the POS terminal 9 and select the “Settle” option. The action is relayed from the POS terminal 9 through the Network Communication Controller 8 up to the Host Server 1. The nature of the settlement request must be specified, e.g. if the settlement process requested is the last one for the day. Otherwise, only the sales transactions will be uploaded for settlement at the Host Server 1. For end of day settlement, the sales transactions as well as the remaining inventory data at the POS terminal 9 memory is transmitted to the Host Server 1 for final settlement. If the number of transactions made at the POS terminal 9 is not equal to the number of transactions recorded on the Host Server 1, reconciliation of sales transaction is done. Settlement is necessary for the reconciliation of sales transactions recorded in POS terminals 9 with those recorded by the Host Server 1. The count of sales transactions from both entities must tally to reflect coherence and normal synchronization of the system operations. An inequivalence signifies that the connection with a certain POS terminal 9 might have been disrupted or disabled. This occurrence serves as a kind of alert and would thereby summon investigation to resolve the problematic cause. In such case, the count of sales transactions stored within the POS terminal 9 is the prevailing data to be followed and eventually reflected in the Host Server 1. The POS terminal 9 will generate a Summary List of the incurred sale transactions in conjunction to the settlement process when the number of transactions made at the POS terminal 9 is equal to the number of transactions recorded at the Host Server 1. After uploading of the transaction to the Host Server 1 is done, the POS terminal 9 memory will be emptied of its previous inventory contents. Before printing of settlement reports, the POS terminal 9 checks the Host Server 1 for any new or deleted products or updated terminal tags. The terminal tags are parameters used for the POS terminal. These terminal tags ensure security for the terminal such as recording time of sales per POS terminal, maximum count of sales transaction of a POS terminal.

If there are terminal tags or product changes made at the Host Server 1, a parameter downloading is done. In parameter downloading, the Host Server 1 first checks if the POS terminal 9 and the terminal user are active. If both are active, the Host Server 1 checks if products are to be downloaded to the POS terminal 9. If there are new or deleted products to be downloaded, the product details are instantly downloaded to the POS terminal 9. If there are no new products to be downloaded, the Host Server 1 checks for the changes to the terminal tags that need downloading. The POS terminal 9 requests all terminal tags from the Host Server 1 and replaces any outdated terminal tags. At all cases where errors are encountered, the E-POS system returns error messages.

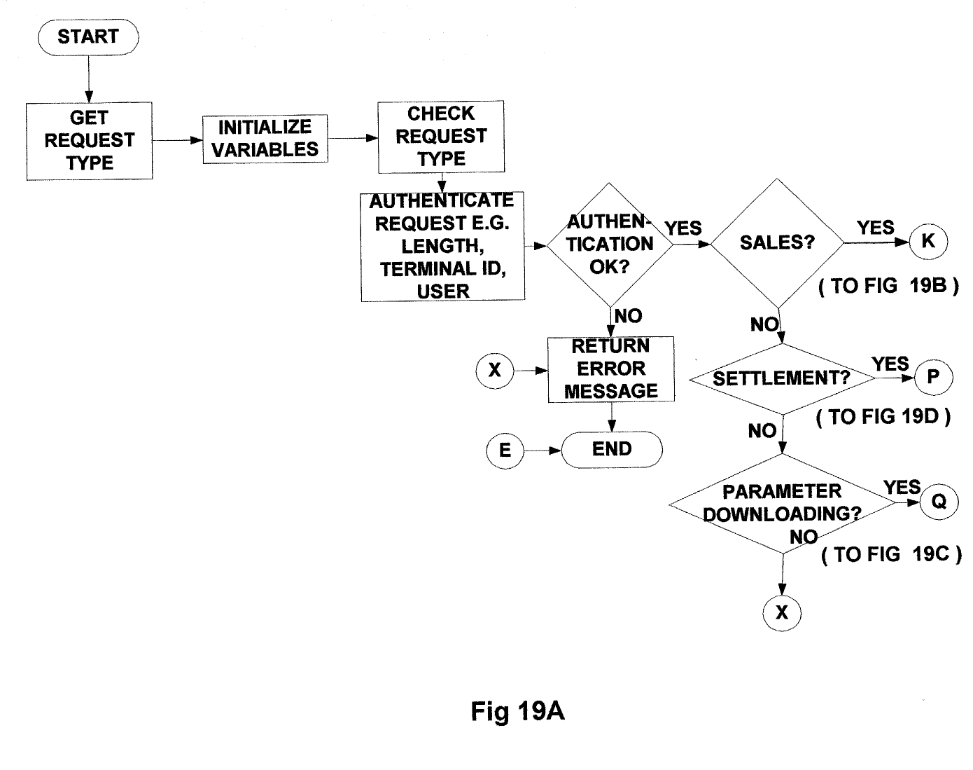

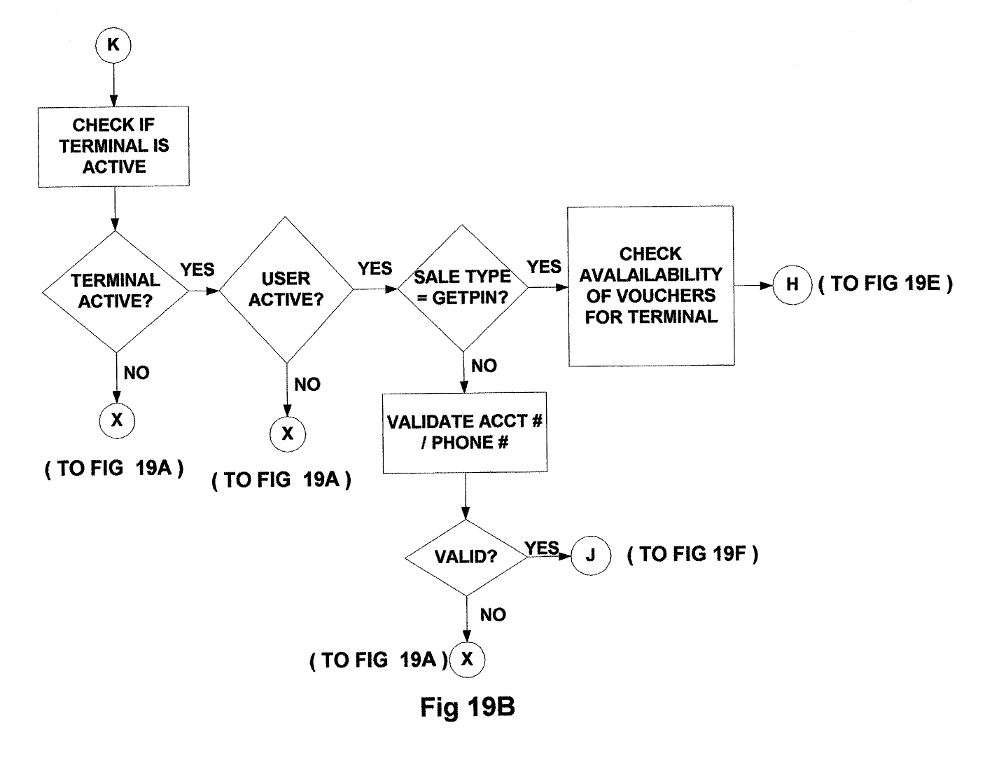

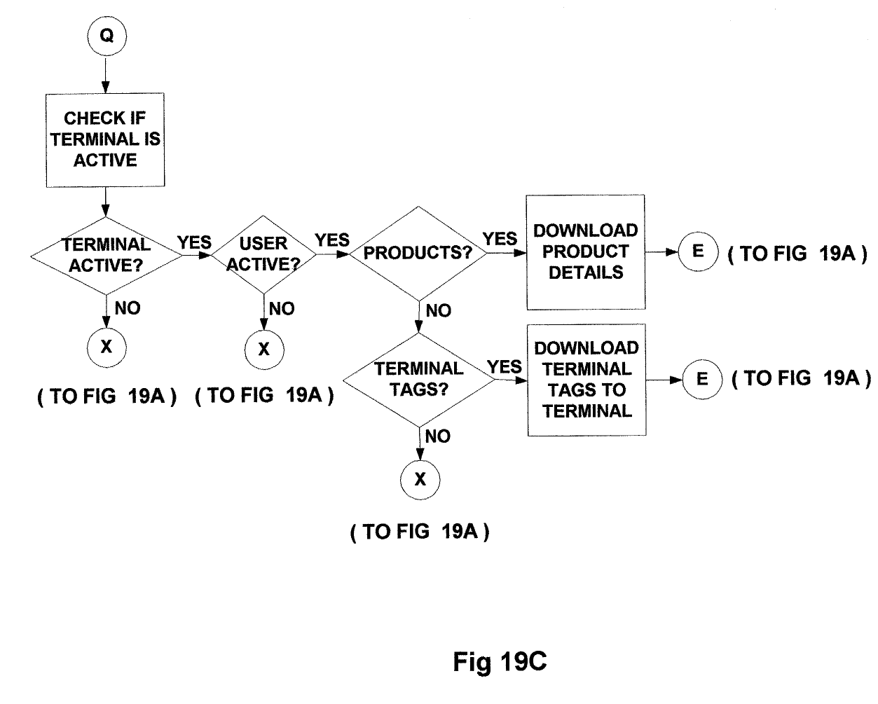

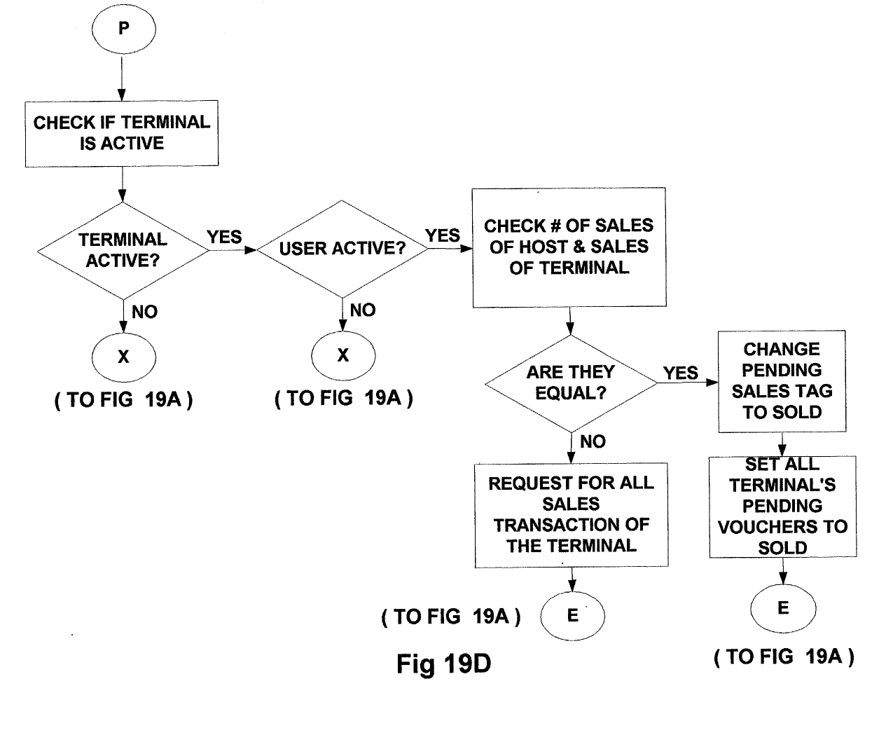

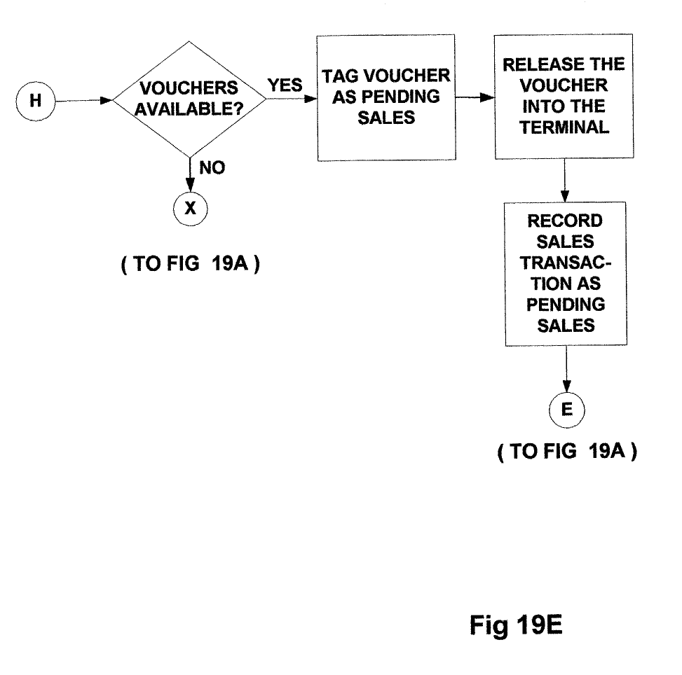

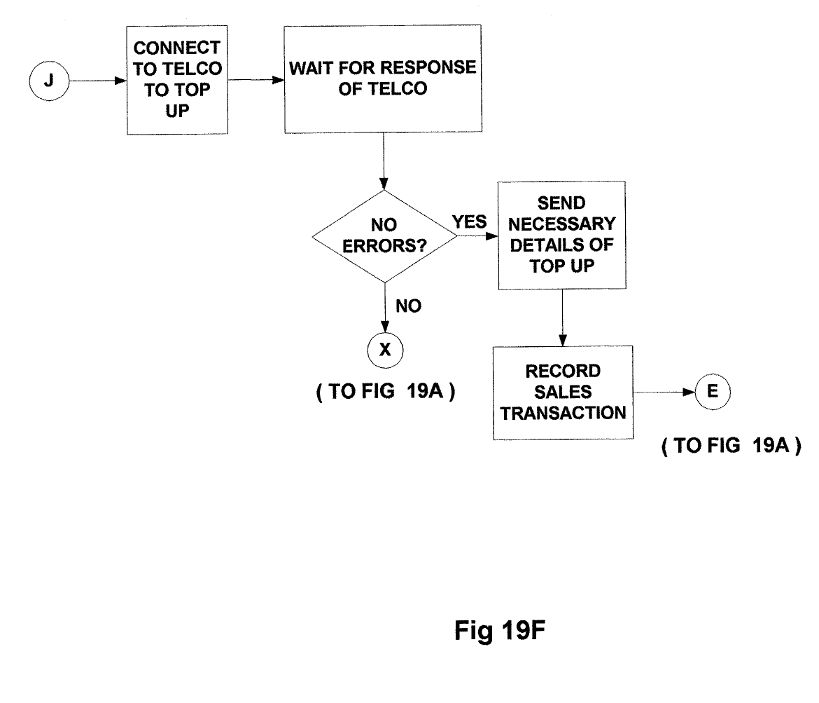

The following describes the steps occurring on the Host Side of the E-POS, i.e. on the system components, prior to download of data to the POS terminal 9, etc. The process flow is shown if FIGS. 19A-B.

The function of the Host Side starts when the Host Server 1 gets a user request type from the POS terminal 9 e.g. sales request, settlement, parameter downloading and initializes the variables. If the request type cannot be verified/authenticated, then the Host Server 1 returns an error message. However, if it is authentic, the Host Server 1 would then solicit from the user such as the accredited distributor or dealer, the transaction to carry out: Sales, Instantaneous Batch Downloading, Settlement, or Parameter Downloading.

If Sales Transaction is chosen, the Host System checks if the POS terminal 9 is active. If POS terminal 9 is active, the Host System then checks if the terminal user is also active. If both are active and the sales type chosen is “GETPIN” which is a term used in the field, the availability of customer request such as sale vouchers for the terminal is checked. GETPIN is chosen if the sales transaction is Batch Downloading or Instantaneous Batch Downloading. Sale vouchers represent the PINs or other information used by the system for the sale transactions such as Card Number PINs. If the consumer requests are available, these vouchers are tagged as pending items and released into the POS terminal 9. At this point, the sales transaction is still a pending sale. However, if the sale vouchers are not available, the process is ended. If the sales type is not “GETPIN”, the customer prepaid account number or mobile phone number if the same are used as customer prepaid account number are requested and subsequently validated. If account number or mobile phone number are valid, the Host Server 1 connects to a telecommunication company to top-up or upload data and it then waits for the TELCO response. If there are no errors encountered, the necessary details of the top-up or upload are sent to the Host Server and the customer request are added to the customer prepaid account number. Conversely, if the account number and phone number are not valid, the process ends.

If Batch Download on a GETPIN in a sales transaction is chosen, the Host System initially checks if the POS terminal 9 and the terminal user are active. If both are active, the Host System then checks the number of available sale vouchers that can be downloaded. If no sale vouchers are available, the process is terminated. However, if vouchers are available, these vouchers are sent to the requesting POS terminal 9, and these vouchers are tagged as pending sales.

If Settlement is chosen, the Host System goes through the same procedure of checking if the POS terminal 9 and the terminal users are active. If they are active, the Host System checks if the number of sale transaction recorded by the Host Server 1 and the POS terminal 9 are equal. If they are equal, sale transactions that were considered pending are changed to sold both at the Host Server 1 and at the POS terminal 9, the POS terminal 9 generates a summary list and the process is terminated. On the other hand, if they are not equal, the Host System request for all sales transaction of the POS terminal 9 and the sales transactions recorded at the Host Server 1 are reconciled with that recorded at the POS terminal 9. After reconciliation, the process is terminated.

If Parameter downloading is chosen, the process starts with the checking if the POS terminal 9 and terminal users are active. If they are active, the system checks and confirms if products will be downloaded. If products are to be downloaded, product details will be downloaded and the process ends. However, if products are not to be downloaded the system asks if terminal tags are the ones to be downloaded. If the terminal user affirms for the terminal tags download, terminal tags will then be downloaded to the POS terminal 9. However, if terminal tags are not to be downloaded, the process returns an error message.

The following letter references were used in FIGS. 19A-B.

X—this reference is used to denote that the E-POS system would return an error message when triggered.

E—signifies the end of any of the process being done by the system due some errors or some yielding of the end of the real process.

K—shows the Sales transaction process of the E-POS system.

P—shows the process of settlement.

Q—shows the process of parameter downloading.

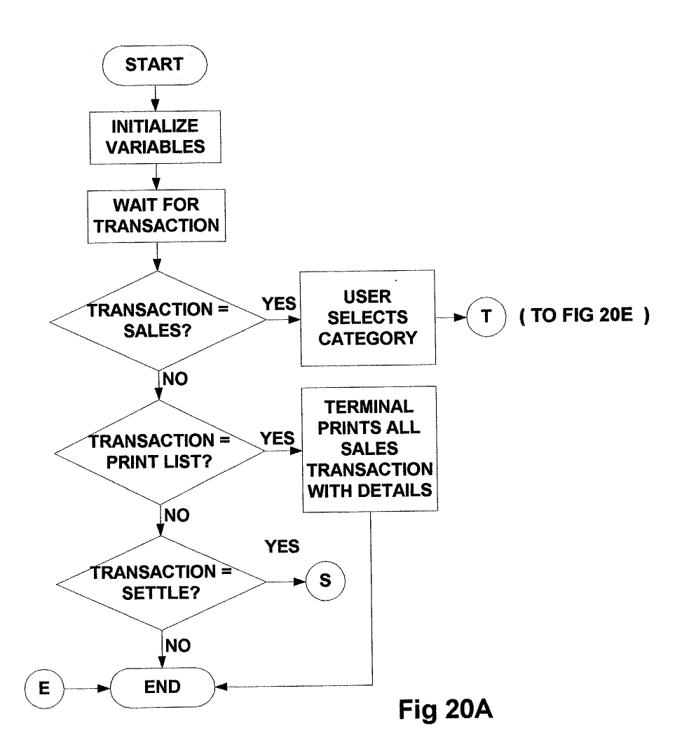

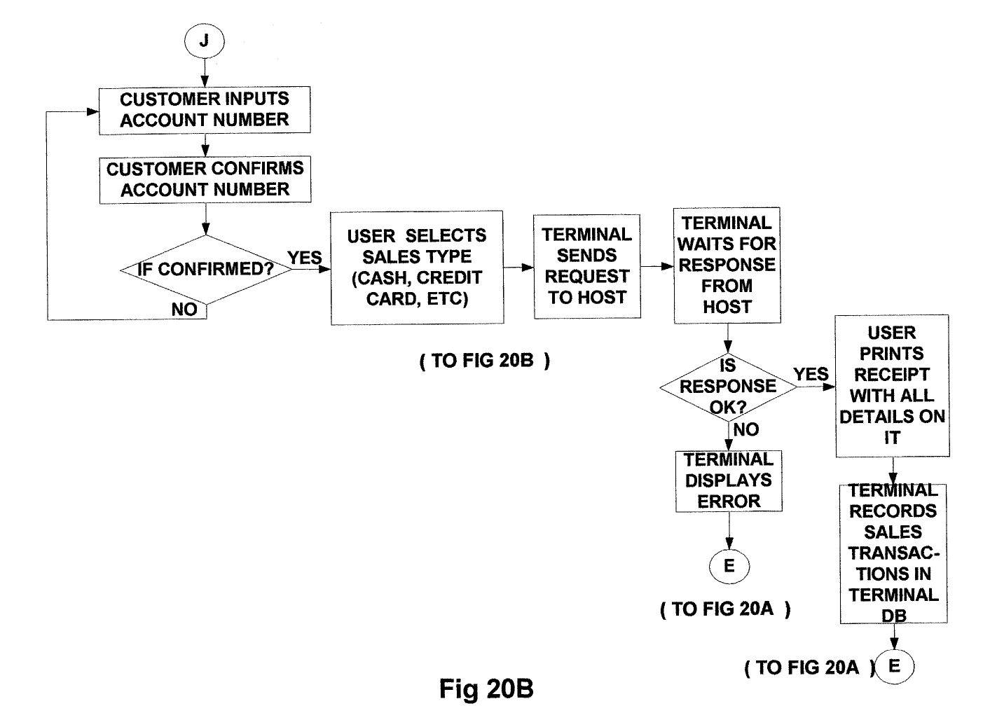

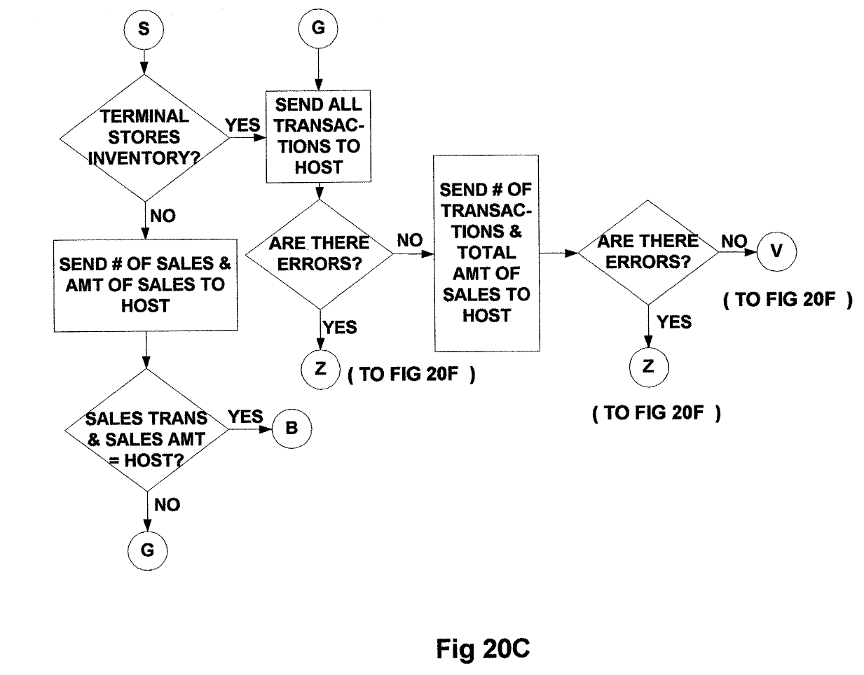

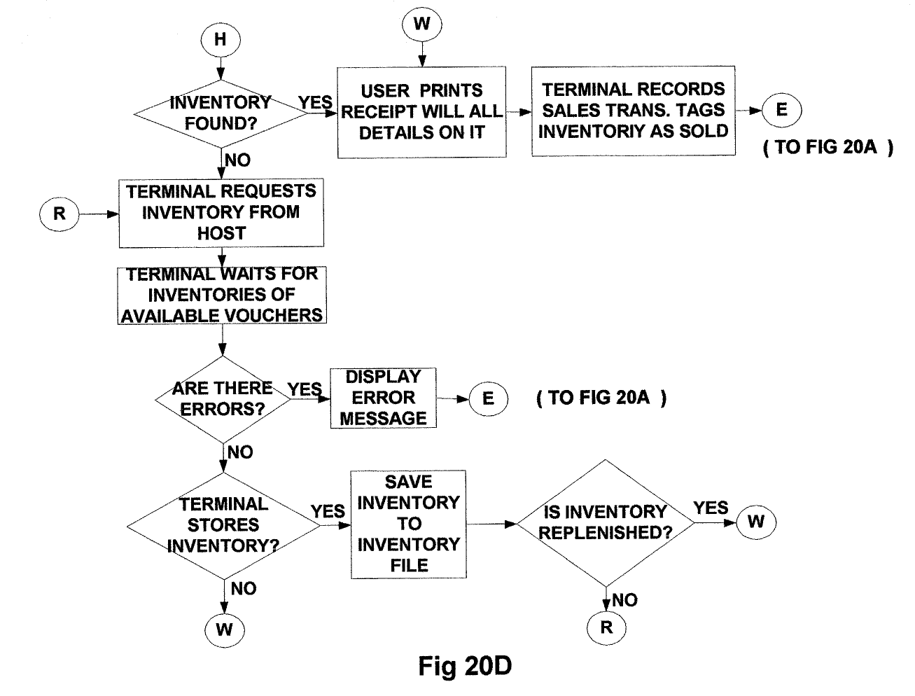

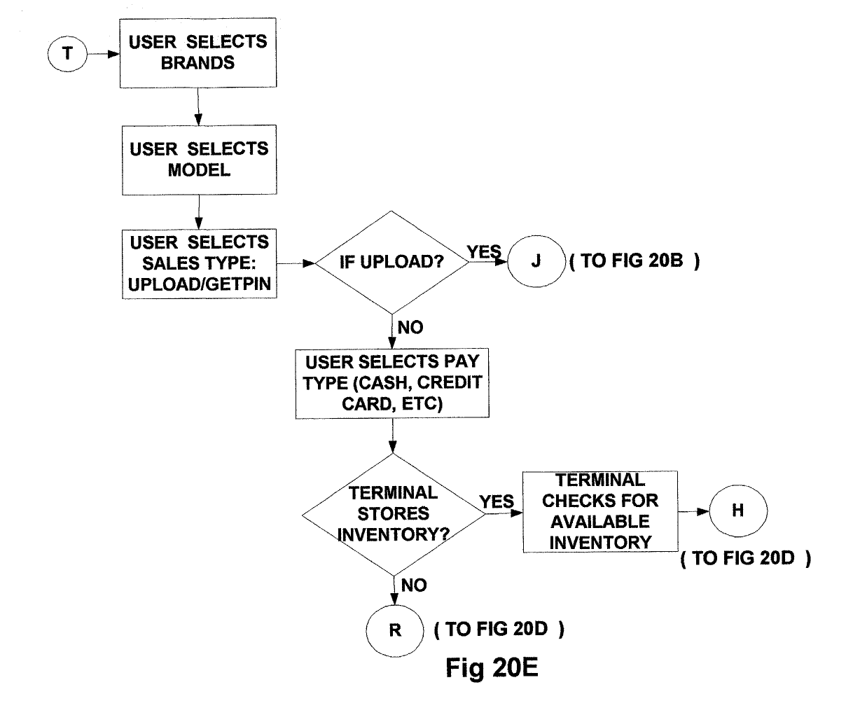

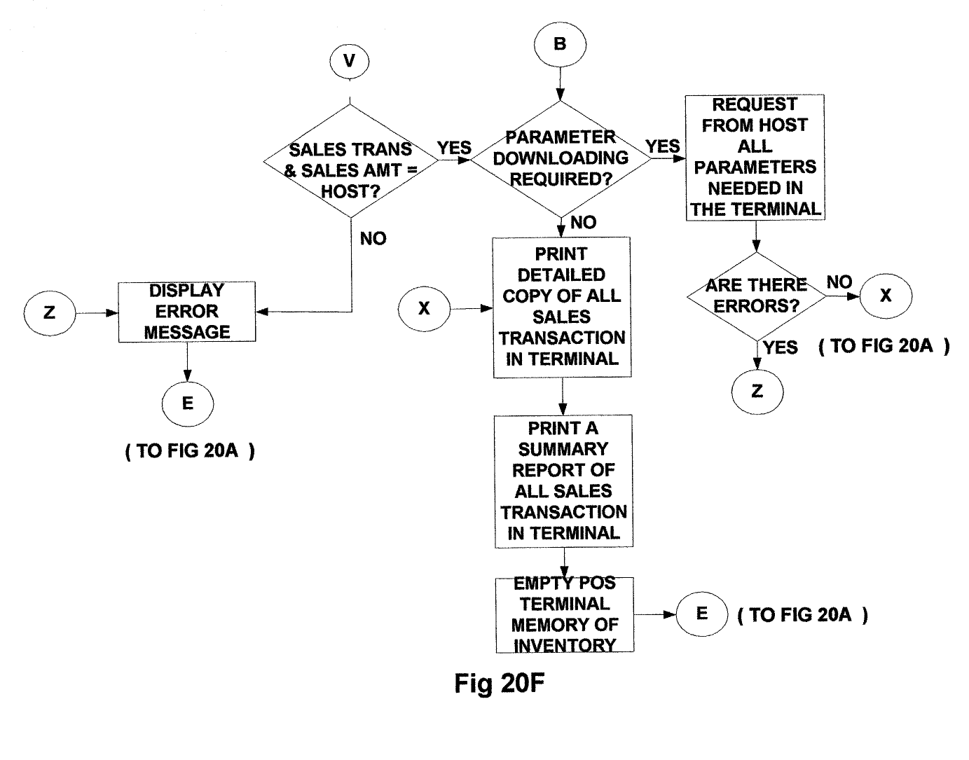

After download of data to the POS terminal 9, the following describes the operations occurring on the POS terminal 9. FIGS. 20A-F show the operation on the POS terminal side of the E-POS system. It shows the interaction between the POS terminal 9 and the user/accredited distributors and dealers, and also between the POS terminal 9 and the Host Server.

The process commences with all variables of the POS terminal 9 initialized. The application then waits for a transaction to be requested e.g. Sales, Print list or Settle. If the chosen transaction is Sales, the process starts with the terminal user's selection of category, for example, brands, model sales type, etc and enters either upload or GETPIN. If upload is chosen, customer inputs their prepaid which is verified by the user. Upon confirmation, the user/accredited distributors start the process and select the customer requested sale voucher. The POS terminal 9 then sends the request to the Host Server 1 and this POS terminal 9 would then wait for the Host Server 1 response. If the response is acceptable, user prints the receipt with all details on it. The POS terminal 9 would then record the sales transactions in the terminal database. However, if the response is not acceptable, an error message is returned. If, on the other hand, GETPIN instead of upload is chosen, the terminal user/accredited distributors and dealers the customer requested sale voucher. The POS terminal 9 would then verify if it stores inventory. If the POS terminal 9 stores inventory, it then checks for available inventory. If there are available inventory, the POS terminal 9 user prints receipt with all the details on it. The POS terminal 9 then records the sales transactions and tags the inventory as sold. If no inventories are found, the POS terminal 9 requests inventory from the Host Server 1. The POS terminal 9 then waits for inventories of available vouchers and check for errors. When no errors are found, the POS terminal 9 is verified if it stores inventory. If the POS terminal 9 stores inventory, the inventories are saved to the inventory file. If the inventory was replenished, the POS terminal 9 user prints receipt with the details on it. As mentioned above, the POS terminal 9 then records the sales transactions and tags the inventory as sold. If errors are found, an error message would be returned. However, if the inventory was not replenished, the process goes back to the POS terminal 9 request for inventory into the Host Server 1 which is referred to as secondary batch downloading. If the transaction chosen is Print list instead of Sales or Settle, the POS terminal 9 prints all sales transaction with details, and the process ends there. If the transaction opted for is Settlement, the process begins with the verification if the POS terminal 9 stores inventory and if it does store inventory, all transactions are sent to the Host Server 1. If no errors are encountered, the number of transactions and total amount of sales are sent to host. If the transmission did not encounter errors and the sales transaction and sales amount are equal to the value kept at the Host Server 1, the POS terminal 9 asks if parameter downloading is required. When it is required, the POS terminal 9 requests from Host Server 1 all parameters, product and/or terminal tags needed in the POS terminal 9. If parameter downloading is not required, detailed copy of all sales transaction and a summary report of all sales transaction in the terminal are printed. After that, POS terminal's memory will be emptied of its previous inventory and sales transactions contents. Should the POS terminal 9 encounter problems, an error message is returned. However, if the POS terminal 9 does not store inventory, all number of sales and amount of sales are sent to the Host Server 1. The POS terminal 9 checks if the sales transaction and sales amount value are equal to that of the Host Server 1 and if they are equal, the process goes back to ask if parameter downloading is required. On the other hand, if sales transaction and sales amount value are not equal to that of the Host Server 1, the process goes back to the process of sending all sales of the transactions of the POS terminal 9 to the Host Server 1.

B—shows the succeeding processes if sales amount and sales transaction are equal to the records kept by the Host Server.

E—signifies the end of a process.

G—shows the succeeding processes if sales amount and sales transaction are not equal to the records kept by the Host Server.

H—shows the procedure after POS terminal 9 checks for available inventory relative to Sales transaction.

J—shows the procedure after upload is chosen in relation to Sales transaction.

T—shows the procedure after terminal user selects category in the Sales transaction.

R—shows the procedure if found out that the POS terminal 9 does not store inventory.

S—shows the procedure in the Settlement transaction.

V—shows the succeeding procedure if no errors are encountered after sending of the number of transactions and total amount of sales to the host.

W—shows what happens next if application found out that POS terminal 9 does not store inventory after finding out that no errors were encountered when terminal waits for inventories of available vouchers.

X—shows the next processes if no errors are encountered after a request to the host for all parameters needed in the POS terminal 9 is carried out relevant to Sales transaction.

Z—represents that the process is the application's returning of an error message.

While the embodiment of the present invention has been described, it should be understood that various changes, modifications and adaptations may be made therein without departing from the spirit of the invention and the scope of the appended claims. Those skilled in the art will recognize that other and further variations of the invention presented herein are possible. The scope of the present invention should be determined by the teachings disclosed herein, the appended claims and their legal equivalents.

I claim:

1. A cardless point-of-sale (POS) system for dispensing prepaid products, replenishing balances or settling an account, comprising:
a server, the server comprising a host server, a database server, the database server storing and distributing data and information on the system, a web server and application server linked by a network/switch hub for routing data through a common transmission control protocol/internet protocol network for network connection to a concentrator;
a POS terminal communicating with the host server through the concentrator, the POS terminal containing memory for programs designed for dispensing prepaid product information;
a network operating system on a separate firewall server, the firewall server shielding the system and the web server;
a router connected to the firewall server, the router acting as a gateway for internet services within the network;
an E-POS back end system within the application server for maintaining a database used in transactions operated by the E-POS system or the database server;
means for initializing the E-POS system,
means for connecting and controlling the communication between the host server and the POS terminal;
means for simultaneously processing multiple transactions;
means for authenticating terminal identification and functions;
means for activating the POS terminal for actual use;
means for providing different levels of secure access to the system web reports;
means for securing the transactions done using the system; and,
means for backing up the database.

2. The system of claim 1, wherein the concentrator is linked to the Host Server which is linked to the network/switch hub.

3. The system of claim 1, wherein the POS terminal has a handset for providing user interface.

4. The system of claim 1 wherein the POS terminal performs confidentiality, connectivity, batch download, sales transaction, transaction storage, transaction printing, transaction group-printing, settlement, dynamic menu, integrity, terminal authentication, terminal lock, terminal unlock, user authentication, advance dial and auto-redial.

5. The system of claim 1, wherein the POS terminal verifies encoded parameters for activating a function or transaction requested.

6. The system of claim 1, wherein the web server acts as repository of computed data for system reports.

7. The system of claim 1, wherein the application server decrypts and converts to a correct format encrypted text received from the web server for importation into the database server; control transaction set up; load inventories to the database server; update terminal parameters; and, monitor the integrity of the system data.

8. The system of claim 1, wherein the concentrator routes the request or transaction information from the host server to the POS terminal.

9. The system of claim 1 further comprising a printer for printing updated new balance and receipt of a sales transaction to a tangible media selected from the group consisting of sealed paper voucher, paper substrate and blank white roll of paper.

10. The system of claim 9, wherein the sealed paper voucher is two-ply having perforated edges glued together on the longitudinal sides, divided into a carbonized customer copy section and a merchant copy section, the sealed paper voucher peelable to reveal hidden downloaded prepaid information from the POS terminal.

11. The system of claim 1 further comprising an intranet residing within the web server for viewing and printing reports of a transaction.

12. The system of claim 1 wherein the E-POS back end system further performs POS management, terminal user access, database management, importation of prepaid PIN numbers and, report management of sales of Settlement Report, Rejected Transactions Report, Daily Sales Report by Dealer/Product, Weekly Sales Report by Dealer/Product, Daily Sales Report by Product, Weekly Sales Report, Daily Sales Report, Weekly Sales Report, Monthly Sales Summary by Dealer, Terminal Logs, Unsettled Terminal List, and, Audit Trails for tracking, evaluation and filing.

13. The system of claim 1 wherein access to the POS back end system is restricted.

14. The system of claim 1 wherein the system provides a separate set of system reports for the exclusive use of E-POS system users having a domain set up at the E-POS system web server or a website linked to the E-POS web server.

15. The system of claim 14 wherein access to the system reports is through a security login module.

16. The system of claim 1 wherein the system performs sequential numbering, time limit for batch download/sales transactions, maximum limit on sales amount/transaction count, and system terminal locking for security and control.

17. The system of claim 1 wherein activation is through an access card having a user identification number randomly generated while a card number is sequentially generated by the E-POS system database.

18. The system of claim 17 wherein the access card has different security level, an administration card for a distributor or dealer having the highest privilege, a settlement card for a store manager for monitoring and operating major terminal transactions, or a sales card for a sales clerk or cashier for activating sales transactions.

19. A process for dispensing prepaid products or prepaid credit replenishment using an E-POS system, comprising:
initializing a terminal for dispensing prepaid product information;
activating a POS terminal by a user;
inputting an encrypted customer request to the POS terminal;
transmitting the encrypted customer request to a host server from the POS terminal through a concentrator by the user;
retrieving and loading the encrypted customer request to an application server, the application server temporarily decrypting and converting the request into a correct database format for storage into a database;
receiving and validating the user request received from the POS terminal by the host server through information stored into a database;
conveying the validated user request to the requesting POS terminal;
checking if both host server and POS terminal are active;
processing the validated user request by the POS terminal; and,
dispensing the user request to the consumer/customer.

20. The process of claim 19 wherein the user request is validated by authenticating that packet format at the POS terminal exists and is active at the packet formats of the host server.

21. The process of claim 19 wherein the host server conveys the manner of processing the validated user request to the POS terminal.

22. The process of claim 19 wherein the initializing comprise generating a random password for the terminal and loading a basic functional program for receiving and dispensing prepaid product information.

23. The process of claim 22 wherein the basic functional program enable the terminal to perform user authentication, connectivity, batch download, sales transactions, transaction storage, transaction printing, transaction group-printing, settlement, dynamic menu, terminal lock, terminal unlock, advance dial, auto-redial, confidentiality, integrity and terminal identification.

24. The process of claim 19 wherein the user request is sales transaction, settlement or parameter downloading.

25. The process of claim 24 wherein sales transaction is done by batch downloading, instantaneous batch downloading or top-up transaction.

26. The process of claim 25 wherein batch downloading comprises performing an initial batch downloading for retrieving sale vouchers and an inventory of customer requests from the host server for downloading into the POS terminal memory, the initial batch downloading allowing the POS terminal to dispense the user request without reconnecting to the host server.

27. The process of claim 26 further comprising a second batch download when any one of the inventory is sold out for replacement.

28. The process of claim 25 wherein instantaneous batch downloading comprises transferring a customer request from the POS terminal through the host server for dispensing.

29. The process of claim 25 wherein Top Up transaction comprises acquiring prepaid accounts directly with a telecommunication company by a customer prior to processing the user request, providing prepaid accounts information to the telecommunication company, adding the user request to the prepaid account of the customer, and confirming the addition of the customer request to the prepaid account by the customer.

30. The process of claim 19 wherein dispensing the user request comprises printing the sale voucher on a tangible media, delivering the tangible media to the customer, and, paying for the customer request.

31. The process of claim 24 wherein settlement comprises selecting settle option at the POS terminal, relaying the settle option to the host server, specifying nature of settlement request to the host server, checking the number of transaction made at POS terminal with that recorded at host server, generating a summary list of the sale transactions by the POS terminal when the number of transactions made at the POS terminal is equal to that recorded at the host server.

32. The process of claim 31 further comprising uploading the summary list of the sales transaction to the host server by the POS terminal for reconciliation with sales transactions recorded by the host server when the number of transactions made at the POS terminal is not equal to that recorded at the host server.

33. The process of claim 24 wherein parameter downloading comprises downloading of products or downloading of terminal tags.

34. The process of claim 33 wherein downloading of products comprises checking and confirming a new or deleted product and downloading product details to the POS terminal.

35. The process of claim 33 wherein downloading of terminal tags comprises checking for changes on terminal tags that need downloading to the POS terminal by the Host Server, and requesting and replacing the downloaded terminal tags by the POS terminal.

36. The process of claim 24 wherein the user request for parameter downloading of new products, deletion of old products and changes on terminal tags do not require reprogramming, reinitialization, collection and redistribution of the POS terminal.
